(19) United States
(12) Patent Application Publication
(10) Pub. No.: US 2021/0172709 A1
(43) Pub. Date: Jun. 10, 2021

(54) Improved Camouflage

(71) Applicant: Hyperstealth Biotechnology Corporation, Maple Ridge (CA)

(72) Inventor: Guy CRAMER, Maple Ridge (CA)

(73) Assignee: Hyperstealth Biotechnology Corporation, Maple Ridge, ON (CA)

(21) Appl. No.: 17/257,735

(22) PCT Filed: Jun. 26, 2019
(86) PCT No.: PCT/CA2019/000098

§ 371 Date: Jan. 4, 2021

Related U.S. Application Data
(60) Provisional application No. 62/693,959, filed on Jul. 4, 2018.
(60) Provisional application No. 62/732,240, filed on Sep. 17, 2018.

(30) Foreign Application Priority Data
Feb. 13, 2019 (CA) PCT/CA2019/000019

(51) Int. Cl. F41H 3/00; G02B 3/00; G02B 1/14; G02B 1/11; G02B 30/27; G02B 30/10

(52) U.S. Cl. CPC F41H 3/00; G02B 3/0062; G02B 30/10; G02B 1/11; G02B 30/27; G02B 1/14

(57) ABSTRACT

The present invention is relates uses of a lens sheet as a camouflaging agent in various applications. Various embodiments of a lens sheet assembly, methods of making the various embodiments of the lens sheet assembly and methods of using embodiments by placing the assembly between an object to be camouflaged and an observer are disclosed. Light from the object undergoes at least one of refraction and reflection such that the object is substantially disguised from the observer.

### CROSS-REFERENCE TO RELATED APPLICATIONS

This application claims priority to U.S. application Ser. No. 62/693,959 entitled “Improved Camouflage”, filed Jul. 4, 2018 the contents of which are incorporated herein in their entirety.

### TECHNICAL FIELD

The present invention relates to improved camouflage generally and in particular to the use of one or more sheets made up of a plurality of interconnected lens materials arranged as a sheet of lenses, and various such combinations, to create improved camouflage.

### BACKGROUND ART

As discussed in the above noted application Ser. No. 62/693,959 entitled “Improved Camouflage”, the concept camouflaging has been a subject of strong interest in a variety of fields of practical human endeavor requiring some form of concealment or privacy, such as arts and entertainment, as well as in the study of wildlife biology and zoology. Aspects of camouflaging such as invisibility have periodically captured public imagination to a very high degree as expressed for example, in popular culture, literary fiction, science fiction, scientific papers and other forms of technical and artistic literature.

The study of camouflage has a surprisingly long history. The ancient Greek philosopher Aristotle had documented his observations of aquatic life in his book, “The History of Animals”, discussing in particular, the ability of an octopus to employ camouflaging by changing its color to resemble its immediate surroundings. More recently, the naturalist Abbott Thayer has advocated for the controversial thesis that all animal coloration has the evolutionary purpose of camouflage, in his well-known book entitled “Concealing-Coloration in the Animal Kingdom”. Others have also written either in support of, or in opposition to similar theses, that were advanced at various times.

In spite of its long history, the study of various forms of camouflage is still an area of active ongoing research and development. Camouflaging activities employ many varied approaches and techniques that often go well beyond simply blending a target object into its background. Camouflaging techniques, often initially observed in wildlife biology, also include color matching, counter-shading, and disruptive coloration.

A very popular topic among the public, as it relates to camouflage, is the concept of an invisibility cloak, which has found ample expression in cultural media such as films and television, particularly with those aimed at a young audience. This has in turn, helped inspire research into light and light-bending materials and related studies of effective arrangements optical instruments in order to achieve the desired effect.

Much theoretical progress has been made in attempts to model how concealment approaches that approximate an invisibility cloak may work. This was the result, primarily of several papers that now provide a theoretical framework for a field of research sometimes called transformation optics.

Although the theoretical modeling associated with transformation optics is relatively new, many of the materials exhibiting interesting optical properties including reflection and refraction are well known. However, useful application of these materials, and underlying principles affecting their interaction with light, has been confined to a relatively small set of contexts.

The practical realization of many of the ideas in transformation optics has been very difficult, due in part to the need for costly setups, specialized materials called metamaterials and other implementation challenges. In contrast to the tangible work of experimental researchers, writers on invisibility cloak technology have largely advanced speculative discourses into its potential future uses. One of the objects of the present invention is to provide improved camouflages, using approaches that are cost effective.

### SUMMARY OF INVENTION

The present invention relates to uses of a ray-optical metamaterials as a camouflaging agent in various applications. Some methods of using of ray-optical metamaterial sheets involve placing the metamaterial between an object to be camouflaged and an observer, whereby light coming from the object undergoes one of: refraction and reflection, such that the object is substantially disguised from the observer.

Aspects of the present invention utilize the phenomena of refraction and reflection of visible light and other waves in the electromagnetic spectrum, via metamaterials or various arrangements of lenses and other optical materials to achieve desirable effects with applicability in architecture, art, entertainment, concealment, signature management, privacy and the like. Materials that are made up of a plurality of lenses, arranged in such a way as to refract and/or reflect visible, near infrared, near ultraviolet or other forms of light or more generally electromagnetic waves, are used to achieve the desired artistic, concealment or visual camouflaging effect.

An example of such a material is a lens sheet, which may have a regular or semi-regular pattern of linear or non-linear shaped lenses, which may be mixed with linear lines within the lens to at least partially reflect or refract light, away from a particular target or onto a desired area. A lenticular plastic sheet is a translucent plastic sheet which has one smooth side while the other side is made of small convex lenses called lenticules that allow the transformation of a two dimensional (2D) image into a variety of visual illusions. Each lenticule acts as a magnifying glass to enlarge and display the portion of the image below i.e., on the smooth side.

Other materials that may be used include an array of small spherical lenses, known as a fly's-eye lens array, or a screen consisting of a large number of small convex lenses. Another example of a material that can be used is a linear or array prism sheet.

In accordance with one aspect of the present invention, there is provided an apparatus for and a method of target concealment and shadow reduction that involves placing a double-sided lens sheet having lenses on both sides, between a viewer and the target object to be concealed. A double-sided lens sheet can be constructed by attaching together the smooth sides of a pair of single-sided lens sheets back-to-back. In this embodiment, corresponding lenses on opposite sides of the double-sided lens sheet are arranged in a staggered manner having an offset relationship to one another. Light from the target passing through the offset double-sided lens sheet is reflected and/or refracted in numerous directions substantially reducing the visibility of the target object or shadow from the target object.

In accordance with another aspect of the present invention, there is provided an apparatus for and a method of target concealment and shadow reduction that involves placing a double-sided lens sheet having lenses on both sides, between a viewer and the target object to be concealed. A double-sided lens sheet can be constructed by attaching together the smooth sides of a pair of single-sided lens sheets back-to-back. In this embodiment, corresponding lenses on opposite sides of the double-sided lens sheet are arranged to line up with one another. Light from the target passing through the in-line double-sided lens sheet is reflected and/or refracted in numerous directions substantially reducing the visibility of the target object or shadow from the target object.

In accordance with another aspect of the present invention, there is provided an apparatus and a method of concealment and shadow reduction that involves placing two double-sided lens sheets (a first double-sided sheet and a second double-sided lens sheet). As noted above, a double-sided lens sheet can be constructed by attaching together the smooth sides of a pair of single-sided lens sheets back-to-back. Light from the target object, passing through the two double-sided lens sheets is reflected and/or refracted in numerous directions substantially reducing the visibility of the target object or shadow from the target object. In this embodiment corresponding lenses on opposite sides of the first double-sided lens sheet are arranged in a staggered manner having an offset relationship to one another, while corresponding lenses on opposite sides of the second double-sided lens sheet are arranged to line up with one another. This embodiment has the advantage of presenting the background scene behind an object to be concealed, without creating a mirror image.

In accordance with another aspect of the present invention, there is provided an apparatus and a method of concealment and shadow reduction that involves placing two double-sided lens sheets (a first double-sided sheet and a second double-sided lens sheet). As noted above, a double-sided lens sheet can be constructed by attaching together the smooth sides of a pair of single-sided lens sheets back-to-back. Light from the target object, passing through the two double-sided lens sheets is reflected and/or refracted in numerous directions substantially reducing the visibility of the target object or shadow from the target object. In this embodiment corresponding lenses on opposite sides of both the first and second double-sided lens sheets are arranged to line up with one another. This embodiment also has the advantage of presenting the background scene behind an object to be concealed correctly, without creating a mirror image. This embodiment also has the advantage of presenting the background scene behind an object to be concealed correctly, without creating a mirror image.

### BRIEF DESCRIPTION OF DRAWINGS

In the figures, which illustrates by way of example only, embodiments of the present invention,

FIG. 1 is a schematic diagram illustrating the principle of the law of refraction as it relates to visible light;

FIG. 2 is a simplified schematic diagram of a lenticular lens sheet, partly in cross-section;

FIG. 3A is a simplified schematic illustration a lens sheet, disposed between a light source and a target;

FIG. 3B is another simplified schematic illustration a lens sheet, disposed between a light source and a target, with the smooth side of the sheet facing the opposite direction;

FIG. 3C is yet another simplified schematic illustration a lens sheet, disposed between a light source and a target, with a plurality lenses on both side of the sheet;

FIG. 4 is a simplified block diagram illustrating a variation of the embodiment of FIG. 3, in which a second lens sheet is disposed between the light source and the target;

FIG. 5 is a block diagram illustrating lenticular lenses used to simulate a three dimensional image;

FIG. 6 is a simplified perspective block diagram of a lens sheet disposed proximate a target;

FIG. 7 is a plan view of the lens sheet of FIG. 2 surrounding a target;

FIG. 8 is a block diagram of a lens sheet made up of a number of linear lenses placed between a viewer and a target;

FIG. 9 a block diagram of another arrangement similar to FIG. 8, with a target having a horizontal profile;

FIG. 10 is a perspective view of a prism sheet made up of a number of one angle prism lenses;

FIG. 11 is a plan view of the prism sheet of FIG. 10 made up of a number of one angle prism lenses;

FIG. 12 is a perspective view of a schematic diagram for a prism sheet, made up of a number of two angle prism lenses;

FIG. 13 is a plan view of the prism sheet of FIG. 12;

FIG. 14 is a simplified schematic diagram of a dove prism lens sheet;

FIG. 15 is a simplified schematic diagram of an offset double-sided lens sheet, disposed between a target and an observer;

FIG. 16 is a simplified schematic diagram of an offset double-sided lens sheet and an in-line double-sided lens sheet, disposed between a target and an observer;

FIG. 17A is a simplified schematic diagram of the offset double-sided lens sheet and an in-line double-sided lens sheet of FIG. 16, disposed between a target and an observer, but with an external offset between the two double-sided lens sheets;

FIG. 17B is a simplified schematic diagram of two offset double-sided lens sheets of FIG. 16, disposed between a target and an observer;

FIG. 18 is a simplified schematic diagram of two in-line double-sided lens sheets, disposed between a target and an observer;

FIG. 19 is a simplified schematic diagram of the two in-line double-sided lens sheets of FIG. 18, with an external offset between the two double-sided lens sheets;

FIGS. 20-22 are schematic illustrations of concealing effects achieved by double-sided lens sheets by merging portions of the background image in a repeating pattern creating neutral strips;

FIGS. 23a-23b are simplified schematic diagrams of an elevation view and plan view, respectively of a single-sided lens sheet disposed between an observer and a background;

FIGS. 24a-24b are simplified schematic diagrams of an elevation view and plan view, respectively of a double-sided lens sheet disposed between an observer and a background;

FIGS. 25a-25b are simplified schematic diagrams of an elevation view and plan view, respectively of two double-sided lens sheets disposed between an observer and a background;

FIGS. 26a-26b are simplified schematic diagrams of an elevation view and plan view, respectively of a double-sided lens sheet disposed between an observer and a background where the two sides have different LPI;

FIGS. 27a-27b are simplified schematic diagrams of an elevation view and plan view, respectively of another double-sided lens sheet disposed between an observer and a background where the two sides have different LPI;

FIGS. 28a-28b are simplified schematic diagrams of an elevation view and plan view, respectively of two double-sided lens sheets disposed between an observer and a background where the two sides of each sheet have different LPI;

FIGS. 29a-29b are simplified schematic diagrams of an elevation view and plan view, respectively of two double-sided lens sheets disposed between an observer and a background where the two sides of each sheet have different LPI;

FIGS. 30a-30b are simplified schematic diagrams of an elevation view and plan view, respectively of two double-sided lens sheets disposed between an observer and a background where the two sides of each sheet have different LPI;

FIGS. 31a-31b are simplified schematic diagrams of an elevation view and plan view, respectively of two double-sided lens sheets disposed between an observer and a background where the two sides of each sheet have different LPI;

FIG. 32 is a simplified perspective view of a single-sided lens sheet having a vertical polarity whereby the lenses are disposed vertically;

FIG. 33 is a simplified perspective view of the lens sheet of FIG. 32 depicting a blurred background image;

FIG. 34 is an elevation view of the background;

FIG. 35 is a simplified perspective view of a single-sided lens sheet having base lenses of a vertical polarity and further having several angled sections of sub-lenses whereby the sub-lenses within the angled sections are disposed at an angle;

FIG. 36 is a simplified perspective view of the lens sheet of FIG. 35 depicting a blurred background image having different types of artifacts caused by the corresponding angled sections;

FIG. 37 is another simplified perspective view of a single-sided lens sheet having base lenses of a vertical polarity and further having several angled complex sections of sub-lenses whereby the sub-lenses within the angled complex sections are disposed at an angle;

FIG. 38 is a simplified perspective view of the lens sheet of FIG. 37 depicting a blurred background image having different types of artifacts caused by the corresponding complex sections;

FIG. 39 is a simplified perspective view of a single-sided lens sheet having base lenses of a first LPI and further having several sections of sub-lenses whereby the base lenses and sub-lenses run vertically, but the sub-lenses within the sections are of a second angle/LPI different from the first LPI;

FIG. 40 is a simplified perspective view of the lens sheet of FIG. 39 depicting a blurred background image having different types of artifacts caused by the corresponding sections;

FIG. 41 is a simplified elevation view of the lens sheet of FIG. 39 placed in front of a background depicting improved concealment;

FIG. 42 is an image as viewed through with two single-sided lens sheets, offset at a first distance to each other, with lenses disposed horizontally in each;

FIG. 43 is another image as viewed through with two single-sided lens sheets, offset at a second distance to each other, with lenses disposed horizontally in each;

FIGS. 44a-44c are images as viewed through with two single-sided lens sheets under water, depicting varied concealment properties depending on the offset between the two sheets;

FIG. 45 depicts two lens sheets disposed back to back, in which a target is partially visible at different perspective viewing locations and completely invisible at others viewing locations;

FIG. 46 is a schematic diagram of a riot shield having a clear shield body and a lens sheet disposed thereon;

FIGS. 47-49 are schematic illustrations of exemplary embodiments of umbrellas made from lens sheets;

FIGS. 50-51 are images of a lens sheet being used to avoid aerial detection;

FIG. 52 is an image of an object to be protected from aerial detection;

FIG. 53 is an image of the object of FIG. 53 covered by a lens sheet to avoid aerial detection;

FIG. 54 is an image of the embodiment shown in FIG. 53 using a military grade night vision equipment;

FIGS. 55, 56a-56b are images of the object of FIG. 55 in the form of a quadcopter drone, utilizing a lens sheet to avoid detection during flight;

FIGS. 57a-57d are illustrations of objects utilizing a cylindrical lens sheet to avoid detection;

FIGS. 58a-58d are illustrations of elongate structures in the form of cellular towers using lens sheets to avoid ground observation while still allowing overhead observation;

FIGS. 59a-59b are images of chain link fence privacy inserts made of lens sheets exemplary of the present invention;

FIG. 60 is an image of a pliable lens sheet having holes like modern camouflage nets;

FIGS. 61a-61b are diagrams of strips of lens sheet material placed on a net framework;

FIG. 62 is another diagram camouflage sheet with matrix of holes on a net framework designed to retain the structural integrity of the sheet;

FIG. 63 is a diagram of a lens sheet with variable lens elements;

FIGS. 64-65 are images illustrating reduced reflection of light through lens sheets;

FIGS. 66-69 are images of an arch shaped lens sheet utilized to conceal a target object;

FIG. 70 is a diagram of a clear corrugated material;

FIG. 71 is a diagram of other corrugated material designs having a piece that functions as a lens with a support structure; and

FIG. 72 is an image of an exemplary aircraft hangar made using lens sheets exemplary of the present invention.

### DESCRIPTION OF EMBODIMENTS

In this description, lens sheets are translucent sheets made up of an array of elongate lenses. These elongate lenses may be small convex lenses called lenticules that are often smooth on one side. In addition to lenticules, these elongate lenses also include prism lenses, dove prism lenses, split dove prism lenses (that is, dove prism lenses longitudinally split in half), one-angle prism lenses, two-angle prism lenses and similar elongate lenses.

Lens sheets with elongate lenses such as lenticules on one side and a smooth flat surface on the opposite side appear to have a variety of interesting visual effects.

In this disclosure, a single-sided lens sheet refers to a lens sheet that has a plurality of elongate lenses typically arranged substantially in parallel on one side, and a smooth, typically flat surface on the opposite side. The lenses may be lenticules, prism lenses, dove prism lenses, split dove prism lenses or split prism lenses.

In this disclosure, a double-sided lens sheet refers to a lens sheet that has a plurality of elongate lenses typically arranged substantially in parallel on each side. Again, the lenses may be lenticules, prism lenses, dove prism lenses, split dove prism lenses or split prism lenses. A double-sided lens sheet can be constructed by affixing or gluing together the flat smooth sides of a pair of single-sided lens sheets back-to-back or by manufacturing a single sheet having lenses on both sides.

### Refraction

It is commonly observed that as a ray of light that enters a material medium at an oblique angle changes its direction. This phenomenon is called refraction. Refraction generally involves a change in the direction of wave propagation due to a change in propagation speed. In the case of light, refraction can be traced to the slowing of the light as it enters the medium, and the speed of light is reduced from its vacuum speed c=3×10⁸ m/s to c/n, where n is the refractive index of the medium.

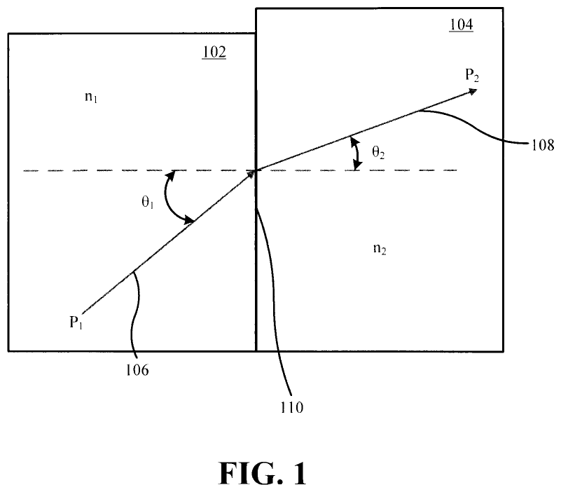

FIG. 1 depicts an illustration of the law of refraction also known as Snell's law. An incident light ray 106 travels from an initial point P₁ through a first medium 102 such as air, and enters into a second medium 104. The incident ray 106 is refracted at the interface 110, so that the trajectory of a refracted ray 108 arrives at the point P₂. This is explained by Fermat's principle of minimum time, which states that light will travel from one point to another along a path that requires the minimum time. The angle of incidence θ₁ and angle of refraction θ₂ must be such as to minimize the optical path length from P₁ to P₂. As shown in FIG. 1, if the refractive index of the first medium and the second medium are n₁ and n₂ respectively, then Snell's law states that n₁ sin θ₁=n₂ sin θ₂.

As noted above, materials that are made up of a large number of lenses, subsets of which are arranged adjacent to one another or in very close proximity in such a way as to refract visible, near infrared and/or near ultraviolet light are known. A typical example is the lens sheet. Lens sheets can be made of translucent plastic. Further, some lens sheets may be smooth on one side while the opposite side may be made up of small convex lenses called lenticules. These lenticules can make an otherwise ordinary two-dimensional (2D) view of a scene, and appear to have a variety of interesting visual effects. For example, a lenticule may act as a magnifying glass.

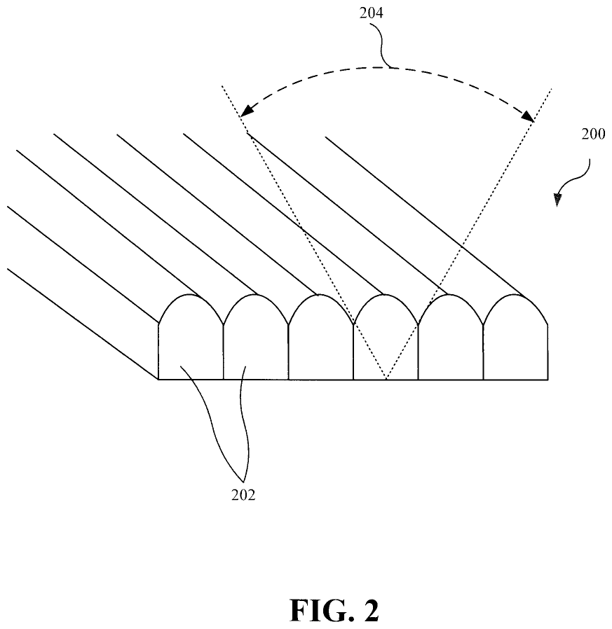

FIG. 2 is a cross-sectional schematic diagram of a lenticular lens sheet. As shown, a lenticular sheet 200 includes a plurality of lenses or lenticules 202. Images from the lenticular lenses can be viewed within a V-shaped viewing region that corresponds to a viewing angle 204. Viewing angle 204 may be small or large. A small viewing angle 204 makes the picture very sensitive to change in the sense that a viewer just needs to turn the head slightly and a different set of pictures will be seen. For wide viewing angle 204 lenses the viewer can make a relatively large displacement or turn of his head to see a different set of pictures so the change in the viewed picture is not as sensitive to the displacement in the head's position or orientation. As a result, narrow viewing angle lenses are good for three dimensional (3D) effects and wide viewing angles lenses are good for dynamic prints such as animation, flip, morph or zoom.

### Development of Sheets of Lens Arrays

A display that presents a three-dimensional image to a viewer without the need for special glasses or other impediments is sometimes referred to as auto-stereoscopic. The first auto-stereoscopic method to appear was the barrier technique, which involved dividing two or more pictures into stripes and aligning them behind a series of vertically aligned opaque bars of the same frequency. It was demonstrated in paintings by G. A. Bois-Clair which would appear to change from one picture to another as a viewer walked by.

Later, physicist Gabriel M. Lippmann used a series of lenses at the picture surface instead of opaque barrier lines, and was able to record a complete spatial image with parallax in all directions. The process utilized an array of small spherical lenses, known as a fly's-eye lens array or integral lens array to record and playback the image.

Several scientists simplified the integral lens array by incorporating a lenticular lens array. A lenticular lens sheet may be made up of a linear array of thick plano-convex cylindrical lenses. The lens sheet is transparent or translucent and the rear face, which constitutes the focal plane, is typically flat. It is also optically analogous to the parallax barrier screen.

Nowadays there are specific lens designs for animation, 3D and large formats and mass production techniques.

### Characteristics of a Lenticular Sheet

Conventional materials used for making a lens sheet are made as clear as possible while maintaining the ability to refract light. Higher transparency of the material is often desirable and in some applications, such as printing, clearer and better visual effects can be realized with a high transmittance rate. The material should also be stable enough to reduce thermally induced distortion so that a sheet of lenticular lenses can be used in many contexts such as being rolled for shipping, or for use in printing presses. A lenticular sheet is typically made from one of: acrylic, polycarbonate, polypropylene, PVC and polystyrene. The lenses may be arranged in an appropriate density, often commonly measured and expressed as lenticules per inch or lens per inch (LPI).

Typical embodiments of the arrangement of these lenses provides a V-shaped viewing region as depicted in FIG. 2 and discussed earlier. The image sensitivity to change in the position of the viewer depends on the viewing angle 204. A small viewing angle 204 makes the picture sensitive to change in that a viewer just needs to turn the head slightly and a different set of pictures will be seen. For wide-angle lenses 204 the viewer can make a relatively bigger head turn to see a different set of pictures so the change is not so sensitive. As a result, narrow viewing angle lenses are suitable for three-dimensional effects, and for dynamic prints.

The material used for making lenticular lens sheets are preferably stable, so that thermal distortion is reduced, while retaining flexibility so that it can be used in a printing press.

### Methods of Manufacture

Lenticular lens sheets are typically manufactured using machines or devices custom made for this purpose. One such device is described, in published US patent application US2005/0286134A1 filed on Aug. 30, 2005, entitled “Lenticular lens pattern-forming device for producing a web roll of lenticular lens”, the contents of which are hereby incorporated by reference in their entirety. The published application describes a lenticular lens and method for manufacturing the lens, in particular as a lenticular lens web, such that finishing operations such as cutting, laminating and various end-use applications of the lens including labeling can be achieved or accommodated in-line with the manufacture of the lens web. The publication also discloses a lenticular pattern-forming device comprising a housing that is rotatable about a central longitudinal axis. The housing has an outer surface having a groove pattern. The groove pattern includes circumferentially and longitudinally extending grooves on the outer surface and the grooves have equal groove widths. The longitudinally extending grooves are substantially parallel with the central longitudinal axis and grooves cover the outer surface of the housing. In addition, the invention further includes a method of using the lenticular pattern-forming device to produce a lenticular lens web, which can be used to make a lenticular image web. The image web can be used to create products such as wallpaper, banners, labels and the like.

Some embodiments of the present invention, that will be described later, relate to the use of lens sheets to achieve improved camouflage. For example, one suitable type of a lenticular lens sheet has been described in U.S. Pat. No. 8,411,363 entitled “Plastic sheets with lenticular lens array”, filed on Oct. 20, 2009, the contents of which are incorporated by reference herein. The patent discloses a lenticular sheet that includes a first surface having at least two portions, an opposing second surface, and a plurality of lenticular lenses formed in the first surface. Each portion of the first surface includes a number of lenticular lenses per centimeter that is different from the number of lenticular lenses per centimeter of an adjacent portion of the first surface.

Several materials may be used to make lens sheets. These include polyethylene terephthalate (PET) which is not amorphous and retains its crystallinity. PET has excellent clarity, good gas barrier properties, and good grease and solvent resistance. Polypropylene (PP) is also suited if the piece is to be finished die cutting lamination or fabrication. Polyvinyl chloride (PVC) which is made by combining ethylene produced by refining petroleum, with chlorine, which is produced from rock salt, may also be used. In general, any translucent or even transparent material such as glass may be used to make such lens sheets.

Specific applications and uses of various types of materials incorporating lenses, methods of making such materials, and articles of manufacture embodying such materials, exemplary of embodiments of the present invention, will be described.

### EMBODIMENT 1—SHADOW REDUCTION

In an exemplary embodiment of the present invention, a material in the form of a lens sheet made up of a plurality of linear lenticular lenses, which may be convex lenses, is utilized to reduce shadow cast by a target object. The lenses would be arranged so as to run parallel to the target. The reduction or elimination of the shadow has several beneficial applications including in greenhouses, solar energy production, architecture, visual mitigation, concealment, and signature management. Materials converting solar energy to electrical energy, often deployed on or as roof tiles may benefit from shadow reduction materials exemplary of embodiments of the present invention.

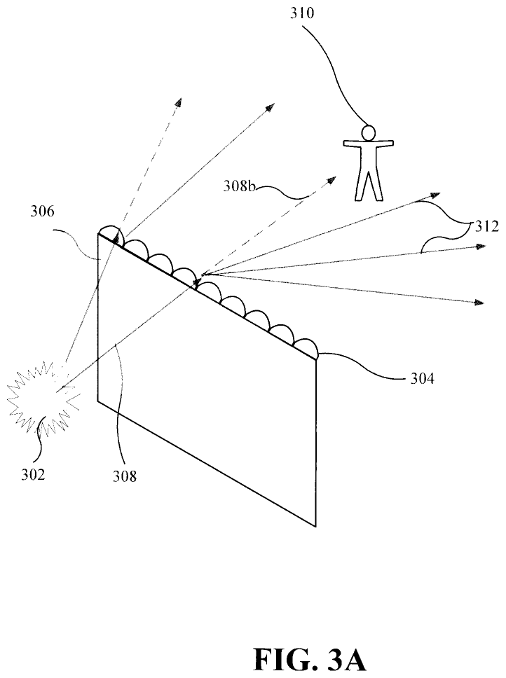

FIG. 3A depicts a simplified schematic illustration of the exemplary embodiment. A light source 302 provides illumination to a sheet 306 of lenses 304 that may be lenticular lenses, placed between the light source 302 and a target 310. Light rays 308 from the light source 302 pass through the lens sheet 306, and a subset of the rays is refracted from the lenticular lenses 304 in numerous directions.

An incident ray 308, which may contribute to shadow formation by target 310, would be refracted by lenses 304. Unlike the hypothetical un-refracted ray 308b. the refracted rays 312 would not directly illuminate target 310 thereby reducing, or in some cases removing, the shadow that would have been cast by the target 310 from the light source 302.

Bending and/or refraction of light can occur in all colors of the visible light spectrum, as well as other non-visible parts of the electromagnetic spectrum, such as infrared and ultraviolet.

In the depicted exemplary embodiment, the target 310 may be a person of typical vertical profile, or another object having substantially greater height than width. In embodiments that have target 310 having such a vertical profile, linear lenses 304 may be placed so that they run parallel to the height of the target 310. The linear lenses may thus be arranged in the same direction, running from the head to the toe of the target person.

In some embodiments, more than one lens sheet may be placed either between a light source 302 and the target 310, or beside the target 310. An antireflective layer, coating, mesh cover, textured surface or other overlay may be required for the smooth surface facing away from the target object and may be required for the opposite side facing the target object.

FIG. 3B depicts a simplified schematic illustration of the exemplary embodiment substantially similar to that depicted in FIG. 3A but with a lens sheet facing the opposite direction. Like elements are identified with like reference numerals with an apostrophe (′) suffixed to those of FIG. 3B to distinguish them from their counterparts in FIG. 3A. Accordingly, a light source 302′ provides illumination to a sheet 306′ of lenses 304′ that may be lenticular lenses, placed between the light source 302′ and a target 310′. Light rays 308′ from the light source 302′ pass through the lens sheet 306′, and a subset of the rays is refracted from the lenticular lenses 304′ in numerous directions.

An incident ray 308′ which may contribute to shadow formation by target 310′ would be refracted by lenses 304′. Unlike the hypothetical un-refracted ray 308b′, the refracted rays 312′ would not directly illuminate target 310′ and thereby reducing, or in some cases removing, the shadow that would have been cast by the target 310′ from the light source 302′.

Bending and/or refraction of light can occur in all colors of the visible light spectrum, as well as other non-visible parts of the electromagnetic spectrum such as infrared. In the depicted exemplary embodiment, the target 310′ may be a person of typical vertical profile; that is, having greater height than width. In embodiments that have target 310′ having such a vertical profile, linear lenses 304′ may be placed so that they run parallel to the height of the target 310′. The linear lenses may thus be arranged in the same direction, running from the head to the toe of the target person.

An undesirable side effect of concealing the foreground object is blurring the background. To reduce blurring of the background, embodiments of the present invention may utilize placing two linear lens sheets back to back, in the same polarity. Alternately, other embodiments use one sheet that has been manufactured with the lenses on both sides, which behaves similarly to a dove prism lens.

FIG. 3C depicts a double-sided linear lens sheet 1300, made by placing two linear lens sheets back to back, in the same polarity. In this arrangement, an object close-up appears in the correct location. Beyond particular distance d, the viewed object farther than location 1310 will appear in the mirror image. The viewed object closer than location 1310 will appear in the correct orientation.

Due to the polarization of the sheets, the effect is to reflect light rays 1304 into reflected rays 1308 by the back-to-back plurality of lenses 1306 so that they converge at location 1310. Thus, objects running in the same polarity can be removed or reduced from view, particularly those in the zone where viewed objects begin to appear in mirror image. While FIG. 3C shows the back-to-back plurality of lenses 1306 running horizontally, the plurality of lenses 1306 may also run vertically or at an angle and still achieve target concealment. In another embodiment, sheet 1300 containing the plurality of lenses 1306 may be curved to make the target concealment region larger.

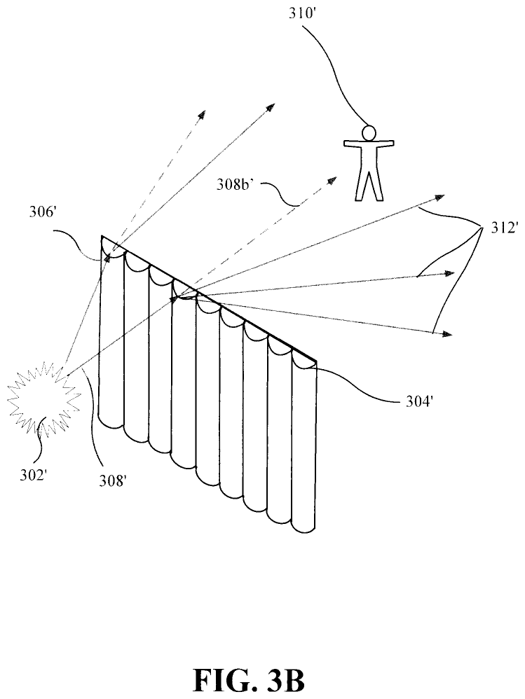

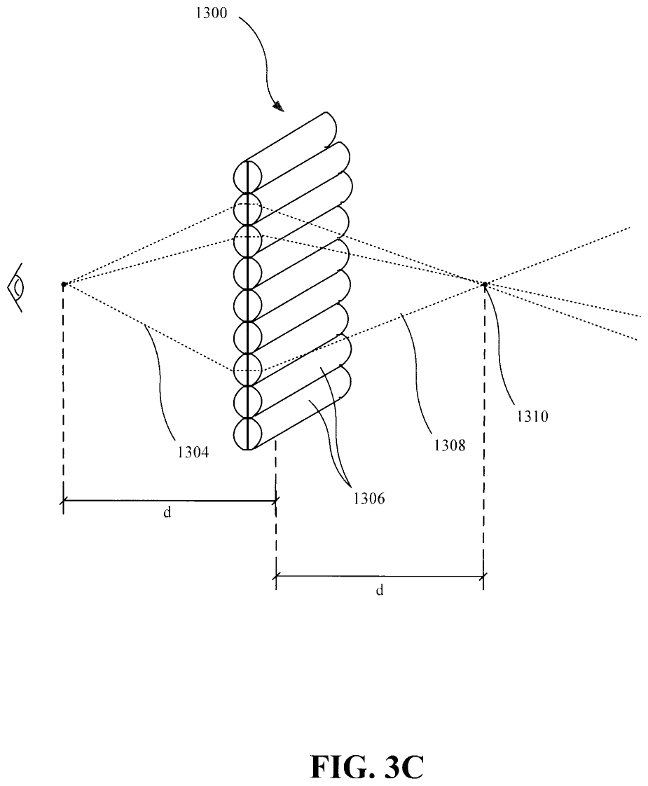

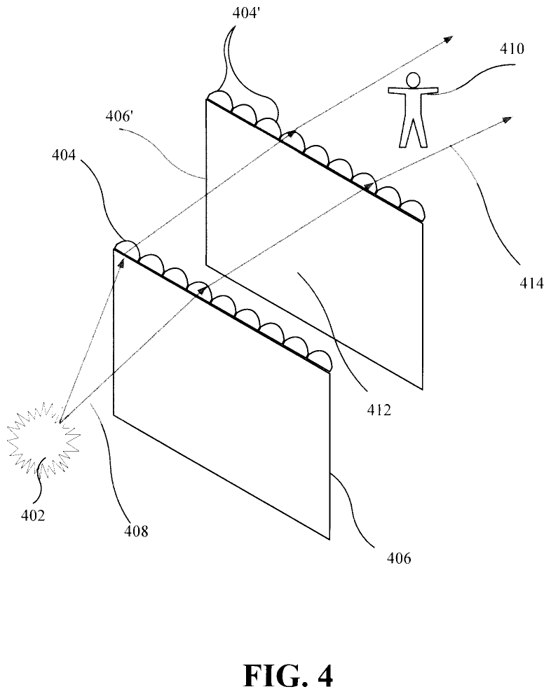

FIG. 4 depicts a simplified schematic illustration of exemplary of another embodiment that utilizes more than one sheet. As shown, a light source 402 provides illumination to a first sheet 406 of lenses 404 placed between the light source 402 and a target 410. Light rays 408 from the light source 402 pass through the lens sheet 406, and a subset of the rays is refracted from the lenticular lenses 404 in numerous directions.

Some of the refracted rays 412 may be refracted again by a second sheet 406′ of lenses 404′ placed between the first sheet 406 and the target 410. In some embodiments, the first and second lens sheets 406, 406′ as well as the lenses 404, 404′ may be substantially similar in construction and optical properties.

A light ray 412 refracted from the first sheet 406 thus passes through the second lens sheet 406′ and is refracted again by lenticular lenses 404′ in numerous directions in the plane of the lenses 404′ thereby reducing or removing the shadow from the target 410.

In other embodiments (not specifically illustrated), at least one lens sheet may be placed beside the target, rather than in front between the light source and the target.

### EMBODIMENT 1.1 SOLAR TOWERS, TUBULAR OR CYLINDRICAL SOLAR CELLS

In a related embodiment, lens sheets maybe used to reduce the shadow of three dimensional (3D) solar towers, where shadows are known to substantially to decrease the output of solar panels and yet owing to their arrangement in close proximity, some towers may cast shadows onto other towers in their vicinity. Examples of such solar towers are described, for example, in M. Bernardi, N. Ferralis, J. H. Wan, R. Villalon and J. C. Grossman, Energy Environ. Sci., 2012, 5, 6880-6884. In this exemplary embodiment, one or more sheets or lenses may be placed in between the light source, which in this case is the sun, and the tower; either on the side of the tower or behind the tower in order to reduce or eliminate the shadow on towers in close proximity.

Examples of tubular or cylindrical solar cells are known. For instance, published US patent application US20100326429A1, entitled “Hermetically sealed cylindrical solar cells” describes a cylindrical shaped solar cell. The cylindrical shaped solar cell unit comprises a substrate that is either tubular shaped or rigid solid rod shaped, a back-electrode circumferentially disposed on the substrate, a semiconductor junction layer circumferentially disposed on the back-electrode, and a transparent conductive layer circumferentially disposed on the semiconductor junction. A transparent tubular casing is circumferentially disposed onto the cylindrical shaped solar cell. A first sealant cap is hermetically sealed to a first end of the transparent tubular casing. A second sealant cap is hermetically sealed to a second end of the transparent tubular casing. In some instances, the solar cell unit is a monolithically integrated arrangement of solar cells. In some instances, the solar cell unit is a solar cell.

U.S. Pat. No. 7,235,736 entitled “Monolithic integration of cylindrical solar cells” assigned to Solyndra Inc. describes a solar cell unit comprising a substrate and a plurality of photovoltaic cells is provided. The substrate has a first end and a second end. The plurality of photovoltaic cells, which are linearly arranged on the substrate, comprises a first photovoltaic cell and a second photovoltaic cell. Each photovoltaic cell in the plurality of photovoltaic cells comprises (i) a back-electrode circumferentially disposed on the substrate, (ii) a semiconductor junction layer circumferentially disposed on the back-electrode, and, (iii) a transparent conductive layer circumferentially disposed on the semiconductor junction. The transparent conductive layer of the first photovoltaic cell in the plurality of photovoltaic cells is in serial electrical communication with the back-electrode of the second photovoltaic cell in the plurality of photovoltaic cells.

U.S. Pat. No. 8,383,929, entitled “Elongated photovoltaic devices, methods of making same, and systems for making same”, describes a non-planar photovoltaic module having a length includes: (a) an elongated non-planar substrate; and (b) a plurality of solar cells disposed on the elongated non-planar substrate, wherein each solar cell in the plurality of solar cells is defined by (i) a plurality of grooves around the non-planar photovoltaic module and (ii) a groove along the length of the photovoltaic module. In some embodiments, each groove of the plurality of grooves about the photovoltaic module, independently, has a repeating pattern, a non-repeating pattern, or is helical. In some embodiments, the module further includes a patterned conductor providing serial electrical communication between adjacent solar cells. In some embodiments, portions of the patterned conductor providing serial electrical communication between adjacent solar cells are within a groove of the plurality of grooves about the photovoltaic module.

Cylindrical solar panels may utilize thin film solar panels wrapped around a series of tubes with white paint underneath to reflect the light that comes through the gaps between the tubes. The lens sheet or lenses are placed underneath a first layer of tubes. The first layer thus provides refraction of light that allows another, second layer of tubes underneath the first layer, to receive light. The first layer may also reflect light from the lenticular lens surface onto the underside of the first layer, which potentially allows for a third or fourth layer with sheets or lenses placed between each layer of tubes allowing for more output while using the same footprint. Exemplary embodiments of the above, as applied to solar towers is disclosed in a co-pending application, assigned to the assignee of the present invention entitled “System and Method of Amplifying Solar Panel Output” the contents of which are hereby incorporated herein in their entirety.

In a variation of the above embodiments, linear prism sheets or array prism sheets may also be used in place of lens sheets. An array of small spherical lenses, known as a fly's-eye lens array may be disposed on a screen. The screen thus contains a very large number of small convex lenses.

In other embodiments applied to solar thermal energy production, mirrors are used to track the sun and reflect sunlight onto a central tower to produce steam, which is used to generate power. The mirrors are placed spaced apart so shadows from neighboring mirrors do not interfere with rays reflected onto the tower. This has the potential for shadow reduction or removal. The mirrors may be placed closer together, thereby generating more reflected light, thereby increasing the power output of the solar tower.

An antireflection film or coating on any of these lenses or sheets may be used to improve shadow reduction by allowing more light to pass through the lenses or sheets.

### EMBODIMENT 2—LIGHT BENDING

In accordance with another embodiment of the present invention, a material having a plurality of lenses may be used to hide or conceal at least a part of the visible part of a target object. The concealment is effected by utilizing the refraction of electromagnetic waves. The range of electromagnetic waves includes, the visible light, short wave infrared (SWIR), near infrared, near ultraviolet ranges, and other ranges of the electromagnetic spectrum. The inventor has conducted experiments that confirmed that the material is able to effect concealment in the SWIR range, which is from 0.9 μm-1.7 μm (900 nm-1700 nm) of wavelength, with scope having a limit of 1.5 μm or 1500 nm as is typical of high-end military night scopes. However, no limits have been established on spectrum range that the material can conceal on either end.

Unlike mid-wave infrared (MWIR) and long-wave infrared (LWIR) light that are emitted from the object itself, SWIR is similar to visible light in that photons are reflected or absorbed by an object, providing the strong contrast needed for high-resolution Ambient star light and background radiance or nightglow naturally emit SWIR and provide excellent illumination for outdoor, nighttime imaging. The material has been shown to bend and/or refract waves in the ultraviolet (UV), visible (VIS), near infrared (NIR) and SWIR ranges, thereby creating a concealment effect.

Advantageously, the material also blocks transmission of thermal signatures or thermal radiation, in the MWIR and LWIR range, from a target hiding behind the material. Thermal radiation is electromagnetic radiation emitted from any substance at a temperature greater than absolute zero, i.e., at any temperature T>0 Kelvin or T>−273.15° C. or T>−459.67° F.

The material shows the ambient temperature of its surrounding area, unless it is close enough to the target to pick up heat from the target. The material has been shown to block transmission of the thermal signature from the target in the MWIR and LWIR ranges, if placed away from the target so as not to pick up heat. In other words, while the material refracts electromagnetic waves in UV, VIS, NIR and SWIR ranges, it actually blocks transmission of the thermal signature from the target in the MWIR and LWIR ranges, if placed away from the target so as not to pick up heat.

This is important as the newest night-vision devices often combine NIR or SWIR with thermal signatures, and are known in the military as “Fusion Night Vision” devices. Fusion Night Vision devices are very difficult to counter with current technology but materials exemplary of embodiments of the present invention are able to conceal targets from detection by Fusion Night Vision devices. The thermal spectrum is blocked, thereby hiding the targets thermal signature behind the exemplary material.

The lenses in the material may be convex lenses, lenticular lenses or other types of lenses arranged in a suitable manner to refract light as described below. Concealment of at least a part of the target from an observer, by utilizing the material, has many applications. As will be appreciated by a person of skill in the art, this property has beneficial uses including architecture, art, entertainment, visual mitigation, concealment and signature management.

As noted above, in addition to shadow reduction, lenticular lenses or sheets of lenticular lenses may be used to conceal of a target from an observer.

### EMBODIMENT 2.1—SIMULATED 3D IMAGE

Lenticular lenses may also be used to create a simulated three dimensional image of a special printed image that appears to be placed behind and against the back of the sheet. The images are not physically displayed directly behind the sheet but rather the lenses create an optical effect or optical illusion, in which the image appears to be beyond the back of the lenses or the sheet, to an observer.

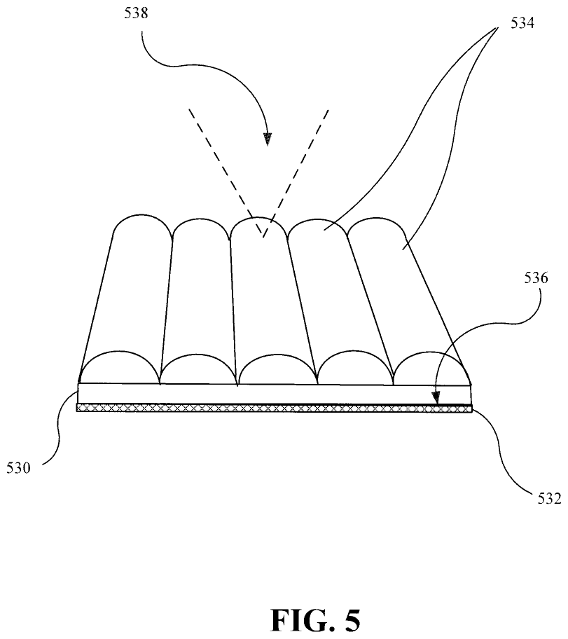

FIG. 5 depicts an arrangement used to create a display with a simulated three dimensional effect. A lens sheet 530 made up of a number of lenticular lenses 534 having a viewing angle 538 is used to create a display with a simulated 3D effect. The lenticular lenses 534 receive light from a special printed image 532 which may be placed directly behind and against the smooth backside 536 of the sheet 530 as shown in the exemplary embodiment depicted in FIG. 5.

### EMBODIMENT 2.3—CONCEALMENT USING FLAT SHEET

By placing one or more lenticular sheets in front or around the target in relation to a viewer, the image or signature of a target object can be drastically reduced or even eliminated with an appropriate standoff distance between the target and the lenticular sheet. The standoff distance may be calculated or computed by taking into account type of lenses used, the angle of the lenses and the frequency of the lenses which is typically specified per square inch.

If the sheet is flat and disposed in between the target and the viewer, then the effect is refraction. The lenses direct light from behind either side of the target object. If the target is far enough from the lenticular sheet, then only a minimal signature is perceived or image observed. Moving the target object back further or moving the lenticular sheet closer to a viewer may eliminate the signature from the target entirely, effectively achieving concealment or near invisibility.

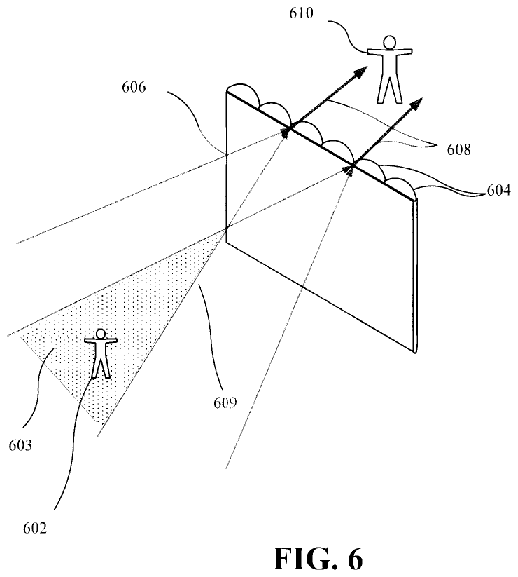

FIG. 6 depicts a simplified schematic illustration of an embodiment exemplary of the present invention. Light rays from a target 602 pass through a sheet 606 of lenses 604 placed between a viewer 610 and the target 602. As light rays from target 602 pass through the lens sheet 606, and they are refracted by the lenticular lenses 604 in numerous directions. Refracted rays 609 help conceal target 602 by creating a dead zone 603 thereby reducing or in some cases, removing the image of the target 602 from view of viewer 610.

### EMBODIMENT 2.3—CONCEALMENT USING CURVED SHEET

If a lens sheet is curved around the target, then an optical effect demonstrated is the bending of the light around the target or refraction/dispersion of light from the target on the inside, as to simulate bending the light around the target as perceived by an observer viewing from outside the cylinder.

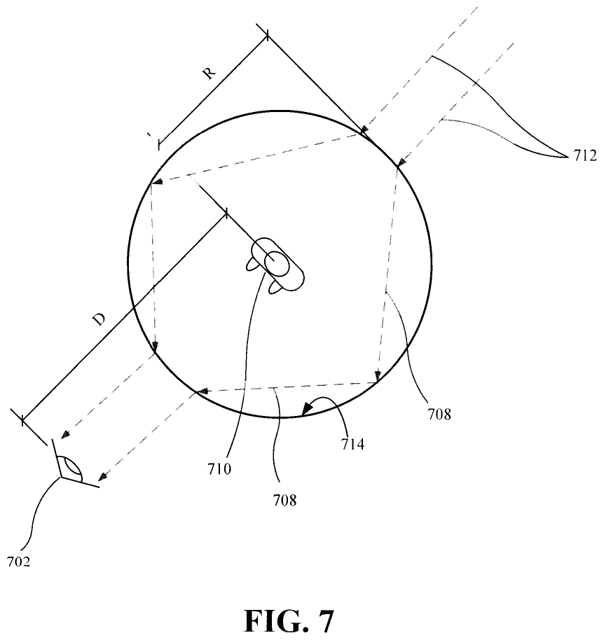

FIG. 7 depicts a plan view of a simplified block diagram of a lens sheet curved into a cylindrical wall 714 around a target 710. The cylindrical wall 714 may be formed by rolling the large lenticular sheet of lenticular lenses into the shape of a cylinder of radius R.

The center of the cylindrical wall 714 may be placed at a suitable standoff distance D between an eye of observer 702 (not drawn to scale) and the target 710, to effectively conceal or substantially reduce the visibility of the target 710. The target 710 is placed in the middle of the cylindrically shaped sheet, away from the cylinder wall 714.

The path traversed by incident light rays 712 can be seen in FIG. 7. As the sheet is curved around the target 710, the effect is effectively bending light around the target 710 (e.g., by way of refracting/dispersing). The refraction, reflection and dispersion of the light rays 708 inside the wall 714 simulates bending the light around the target 710 as perceived by observer 702 viewing from the outside of the cylinder wall 714.

The inventor has found that if a target is on the outside of the opposite side of the cylinder to the viewer, then there is a region close to the cylinder where the target cannot be seen.

### EMBODIMENT 2.4—CONCEALMENT OF AN OBJECT WITH VERTICAL PROFILE

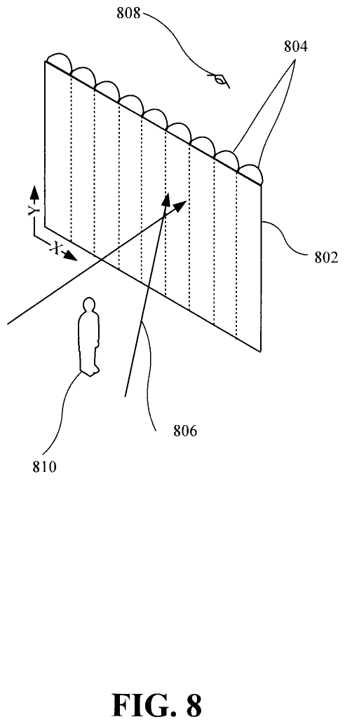

FIG. 8 depicts a lens sheet 802 made up of a number of linear lenses 804 that are placed between a viewer 808 and a target 810. The lenticular lenses 804 have lengths running in the same Y direction as the target 810, that is, a person standing along the Y direction. The lens sheet 802 lies in the X-Y plane as depicted. Using the arrangement as depicted in FIG. 8, refracted light rays 806 conceal the target 810 from a viewer 808.

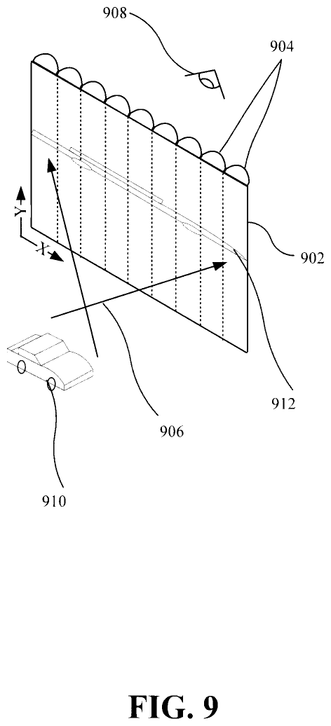

As noted earlier, when the target 810 has a vertical profile, that is, having greater height along the Y direction, than width along the X direction, then the linear lenses should be run along the same Y direction to improve concealment. This is illustrated with a contrasting scenario depicted in FIG. 9.

FIG. 9 illustrates another arrangement similar to FIG. 8, but with a target 910 having a horizontal profile. As shown, a lens sheet 902 made up of a number of linear lenses 904 that are placed between a viewer 908 and the target 910. The linear lenses 904 have their lengths running in the Y direction whereas the target 910, that is a vehicle having a greater width along the X direction than height in the Y direction.

The lens sheet 902 lies in the X-Y plane as depicted. Using the arrangement as depicted in FIG. 9, refracted light rays 906 may not be able to conceal the target 910 from a viewer 908 completely because image 912 may still be viewable. To better conceal target 910. which has a greater width than height, lens sheet 902, can be turned so the lenticular lenses run horizontally.

### EMBODIMENT 2.5—PRISM SHEETS

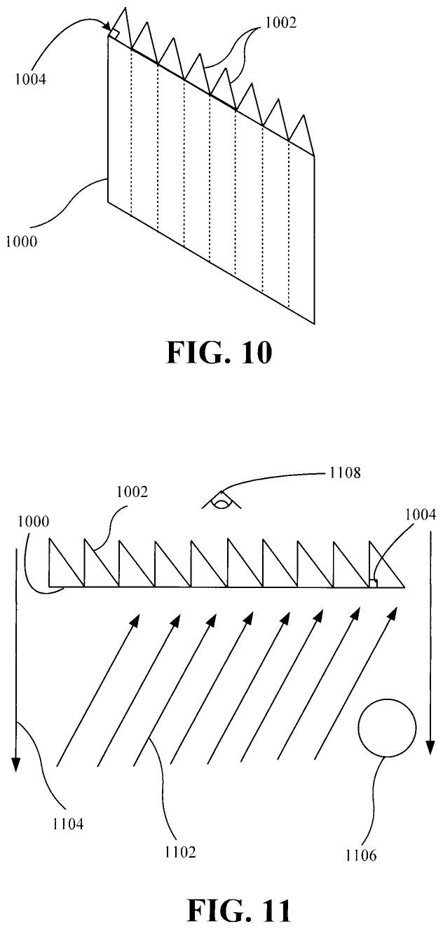

In other embodiments, a similar effect of removing a target from view may be accomplished with a two angle or one angle prism sheet. FIG. 10 depicts a prism sheet 1000 made up of a number of one angle prism lenses 1002. The prism lenses are right angled at one angle 1004.

FIG. 11 depicts a plan view of the prism sheet 1000 of FIG. 11 made up of a number of one angle prism lenses 1002. The prism lenses are right angled as shown at angle 1004. The refraction of light rays 1102 helps conceal or hide the target 1106 from an observer 1108. A second set of lenses in the opposite angle may continue to the right to allow the target 1106 to be hidden in the middle of the sheet 1000.

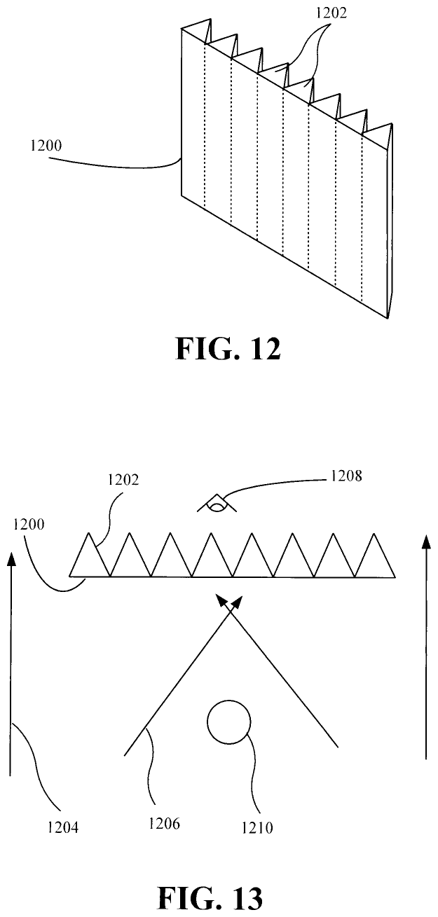

In yet another embodiment, a similar effect of removing a target from view may be accomplished with a two-angle prism sheet. FIG. 12 depicts a prism sheet 1200 made up of a number of one angle prism lenses 1202. Unlike in FIG. 10 or FIG. 11, there are no right angles for the prism lenses.

FIG. 13 depicts a plan view of the prism sheet 1200 of FIG. 12. As may be seen, the prism sheet 1200 is made up of a number of two angle prism lenses 1202. Prism sheet 1200 is disposed between an observer 1208 source and a target 1210.

The refraction of light rays 1206 as depicted, helps conceal or hide the target 1210 from the observer 1208. The trajectories of other light rays 1204 that have not been refracted remain unchanged and thus neither contribute nor impede the concealment of target 1210.

### EMBODIMENT 2.6—BACK-TO-BACK LINEAR LENS SHEETS

As mentioned earlier, an undesirable side effect of concealing the foreground object is blurring the background. To reduce blurring of the background, embodiments of the present invention may utilize a dove prism lens sheet.

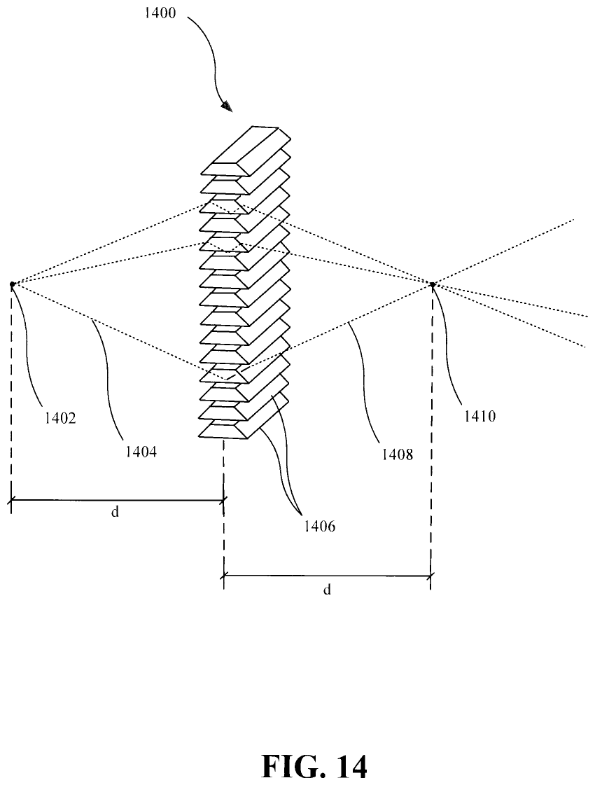

FIG. 14 depicts a dove-prism lens sheet 1400 where a viewer at location 1402 views an object at some distance from the lens sheet 1400. A target object placed between sheet 1400 and location 1410 will appear in the correct orientation to the viewer at location 1402. However, an object placed farther away than location 1410 from sheet 1400 will appear in mirror image.

Due to the polarization of the sheets, the effect is to reflect light rays 1404 into reflected rays 1408 by the prisms 1406 so that they converge at location 1410. Thus, objects running in the same polarity can be removed or reduced from view, particularly those around the zone farther away from the lens sheet 1400 than location 1410 where viewed objects begin to appear in mirror image.

Negative refraction is the unusual bending of light that does not normally occur in nature. It has been observed that materials with negative permittivity and permeability possess a negative refractive index. Such materials have been recently built in the form of metamaterials—resonant electromagnetic structures periodic on a scale below the wavelength, where they act as a homogeneous optical medium. Ray-optical components such as lenses can also be miniaturized and arranged periodically. Simple combinations of such periodic arrangements can be used but these are not metamaterials. They affect passing light waves very much like inhomogeneous media. However, they can affect light rays like homogeneous media. In this sense, they can be considered to be ray-optical metamaterials.

### EMBODIMENT 2.7—OFFSET DOUBLE-SIDED LENS SHEET

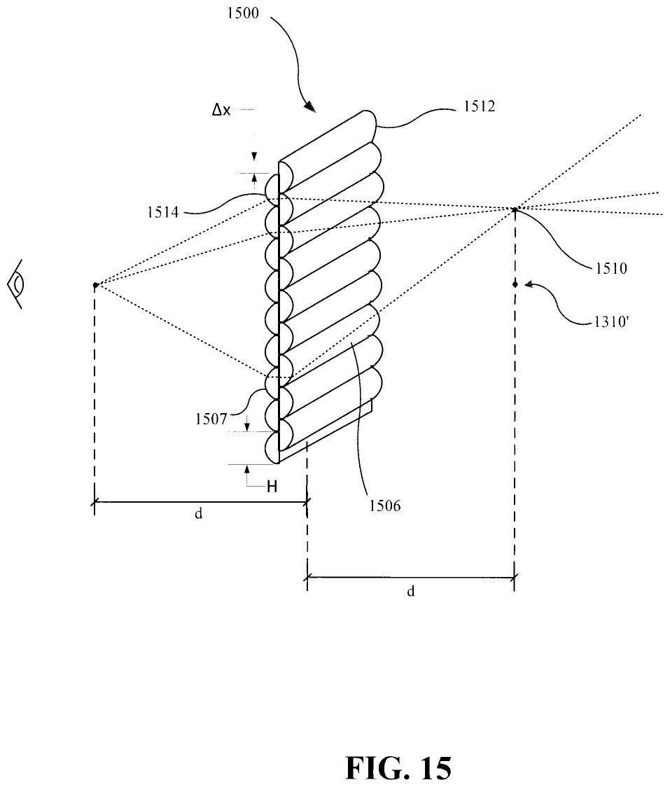

FIG. 15 depicts an offset double-sided lens sheet 1500 exemplary of an embodiment of the present invention. An exemplary method of target concealment and shadow reduction using the embodiment of FIG. 15 involves placing double-sided lens sheet 1500 having lenticular lenses on both sides of the sheet, between a viewer and the target object to be concealed.

In the embodiment of FIG. 15, it can be seen that corresponding lenses on opposite sides of the double-sided lens sheet 1500 (such as lens 1512 and lens 1514) are arranged in a staggered manner, having an offset relationship to one another. The offset distance is depicted as Δx in FIG. 15. The offset distance Δx may be in the range 0<Δx<H, where H is the height (or diameter—when the lens is a half-cylinder) of the lenticular lens as shown in FIG. 15.

Light rays from the target object passing through the double-sided lens sheet 1500 are refracted in numerous directions with the effect being substantial reduction in the visibility of the target object and its shadow.

In this arrangement, an object at a particular distance d, viewed beyond location 1510 will appear in mirror image. Due to the polarization of the sheets, the effect is to reflect light rays by the back-to-back plurality of lenses 1506, 1507 so that they converge at location 1510, with the other similarly reflected rays.

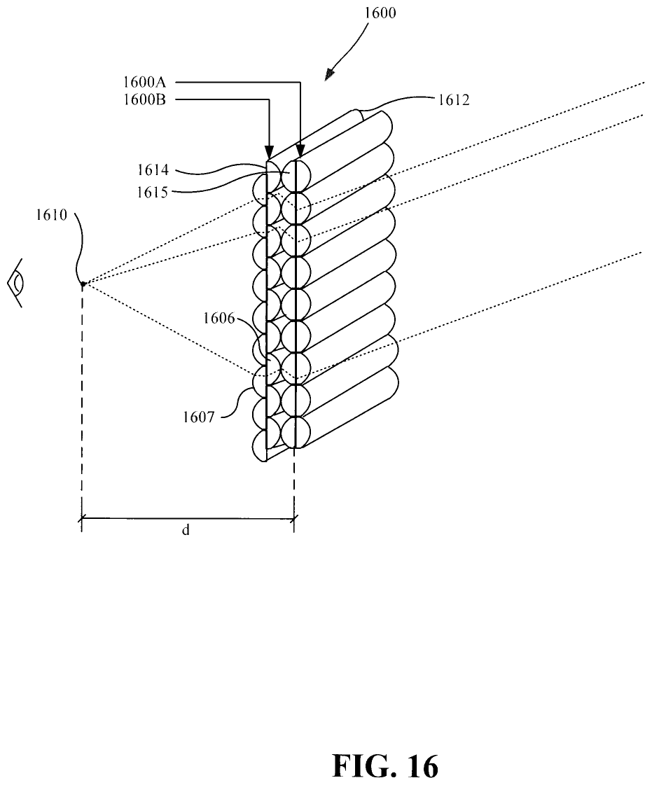

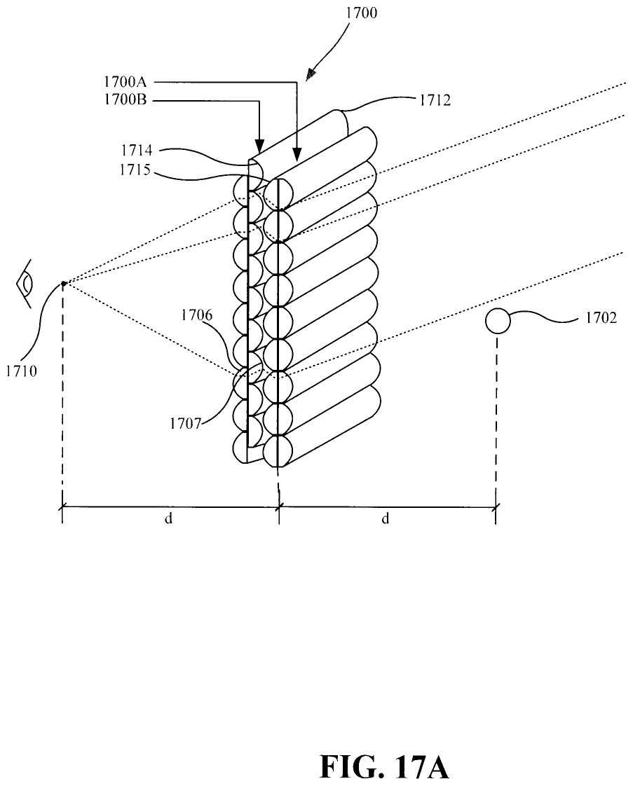

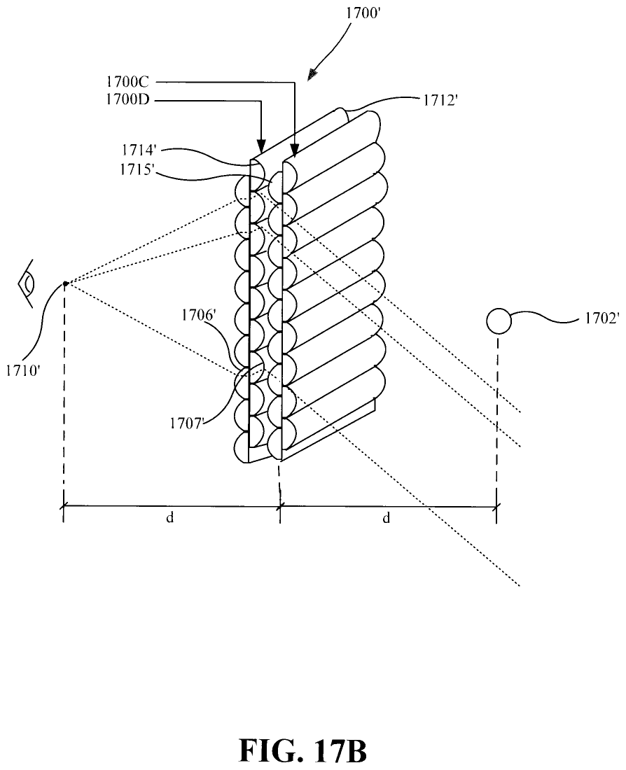

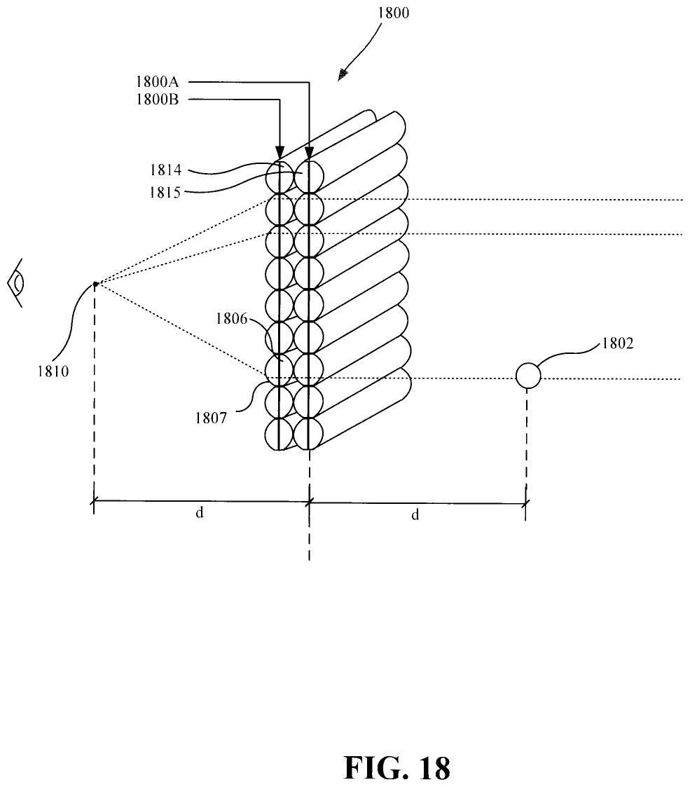

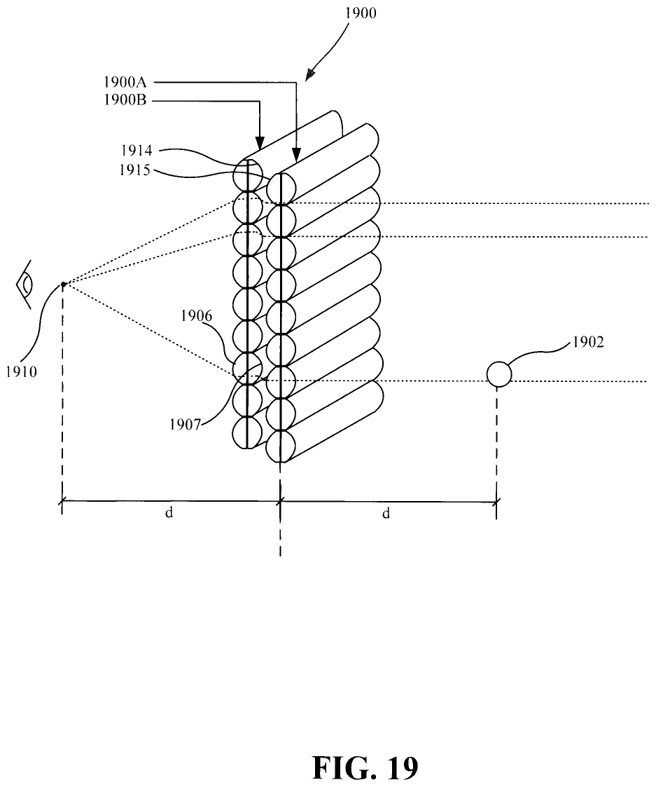

One way to correct the mirror image is to dispose a double-sided lens proximate lens sheet 1500. Such an arrangement is shown in FIG. 16, FIG. 17, FIG. 18 and FIG. 19. The offset will shift the view of the background left or right, if the lenses are running vertically.

In the embodiments of FIG. 3C, FIG. 14 and FIG. 15, a target will appear in mirror image if the target is farther, that is to the right, beyond location 1310, 1410 or 1510 respectively.

As may be appreciated, the convergence location 1510, is at a different location than convergence location 1310′ corresponding to the embodiment of FIG. 3C where the lenses are inline rather than offset. It is to be noted that while the convergence location 1310′ and convergence location 1510 are at different locations, they remain on the same or substantially the same plane, at the same distance d, away from and parallel to, the place of the lens sheet 1500.

The convergence location 1510, can be controlled by the offset distance Δx. As will be described later, certain methods of making double-sided lens sheets (e.g., adding water between two single-sided lens sheets) permit the offset distance Δx to be varied with relative ease which allows for adaptation of the embodiments described to specific contexts depending of the distance d, and other factors.

Thus, objects having the same polarity can be removed or reduced in visibility, particularly those viewed in the zone around location 1510. While FIG. 15 shows the lenses 1506 running horizontally, as would be appreciated by persons of skill in the art, the lenses 1506 may also run vertically or at an angle and still achieve target concealment. In another embodiment, a sheet similar to sheet 1500 containing the plurality of lenses 1506 may be curved to make the target concealment region larger. This offset provides the ability to shift the background and target to the left or right, if the lens polarity is vertical, if the shift is great enough then the target is removed from view.

### EMBODIMENT 2.8—AN OFFSET DOUBLE-SIDED LENS SHEET AND AN IN-LINE DOUBLE-SIDED LENS SHEET

FIG. 16 shows two double-sided lens sheets disposed in close proximity, depicted as a first sheet 1600A, and a second sheet 1600B (collectively sheets 1600) exemplary of an embodiment of the present invention. A method of target concealment and shadow reduction using the embodiment of FIG. 16 involves placing these two double-sided lens sheets 1600, each having lenses on both sides, between a viewer and the target object to be concealed.

In the embodiment of FIG. 16, it can be seen that corresponding lenses on opposite sides of the offset double-sided lens sheet 1600A (e.g., lens 1612 and lens 1614) are arranged in a staggered manner having an offset relationship to one another. However, corresponding lenses on opposite sides of the second double-sided lens sheet 1600B are arranged to line up with one another.

Corresponding lenses on opposite sides of on the in-line double-sided lens sheet 1600B are thus at the same distance relative to the top or bottom of the sheet. Of course, in vertically polarized embodiments where lenses are disposed vertically, corresponding vertical lenses on opposite sides of the in-line double-sided lens sheet would be the same level or height relative to left or right of the sheet.

This embodiment has the advantage of presenting the background scene behind an object to be concealed correctly, without creating a mirror image. Light rays from the target object passing through the offset double-sided lens sheet 1600A and the in-line double-sided lens sheet 1600B is refracted and/or reflected in angles substantially reducing the visibility of the target object or its shadow.

In this arrangement, in contrast to the embodiment of FIG. 3C, an object at a particular distance d, when viewed at location 1610 will not appear in the mirror image. Due to the polarization of the lenses in sheets 1600, the effect is to reflect light rays into reflected rays by lenses 1606, 1607 which are offset unlike the embodiment of FIG. 3C where the lenses are inline.

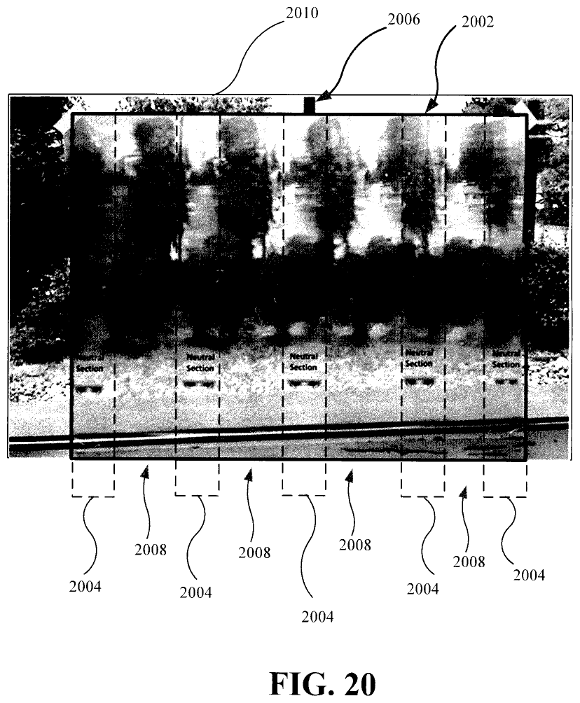

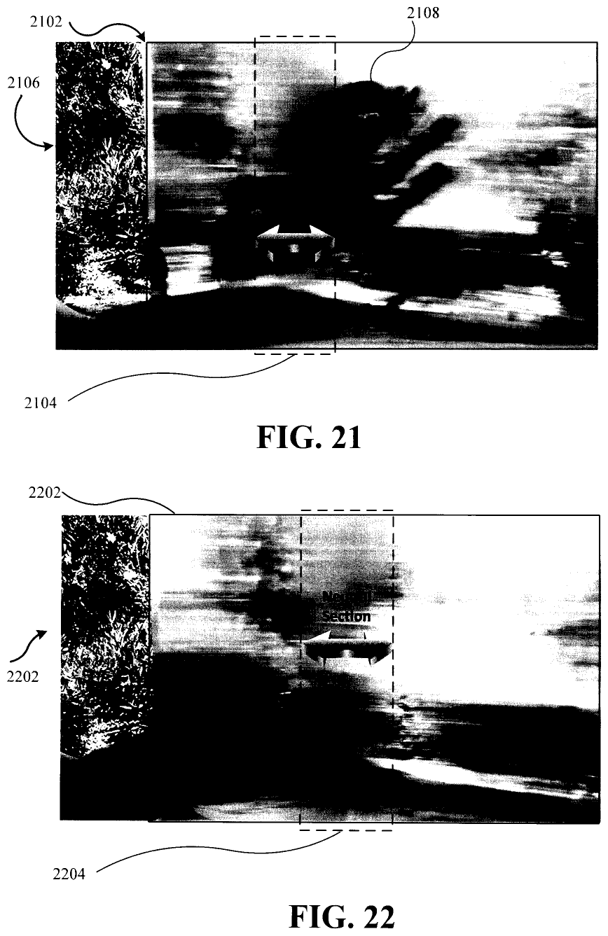

Objects of any polarity can be removed or reduced in visibility by shifting the angle and removing the object (and surrounding background) out of the field of view or by utilizing the neutral sections objects of the same polarity can be reduced or removed from view which will be discussed in FIG. 20, FIG. 21, and FIG. 22. Objects of the opposing polarity may also be removed or reduced in visibility if their width can be hidden in these neutral sections.

While FIG. 16 shows the plurality of lenses 1606, 1607 running horizontally, the plurality of lenses may also run vertically or at an angle and still achieve target concealment. In another embodiment, a sheet similar to sheets 1600 containing the plurality of lenses may be curved to make the target concealment region larger.

### EMBODIMENT 2.9—EXTERNAL OFFSET BETWEEN AN OFFSET DOUBLE-SIDED LENS SHEET AND AN IN-LINE DOUBLE-SIDED LENS SHEET

FIG. 17A shows two double-sided lens sheets disposed in close proximity, depicted as a first sheet 1700A, and a second sheet 1700B (collectively sheets 1700) exemplary of another embodiment of the present invention. A method of target concealment and shadow reduction using the embodiment of FIG. 17A involves placing these two double-sided lens sheets 1700, each having lenses on both sides, between a viewer and the target object to be concealed. This embodiment has been found to have the same effect as the embedment of FIG. 16.

In the embodiment of FIG. 17A, it can be seen that corresponding lenses on opposite sides of the offset double-sided lens sheet 1700A (e.g., lens 1706 and lens 1707) are arranged in a staggered manner having an offset relationship to one another. However, corresponding lenses on opposite sides of the second double-sided lens sheet 1700B are arranged to line up with one another.

Corresponding lenses 1714, 1715 on the double-sided lens sheets 1700A, 1700B respectively are thus at different distances relative to a common bottom and hence externally offset or staggered. Of course, in vertically polarized embodiments where lenses are disposed vertically, corresponding vertical lenses on opposite sides of the in-line double-sided lens sheet would be the same level or height relative to left or right of the sheet.

This embodiment has the advantage of presenting the background scene behind an object to be concealed correctly, without creating a mirror image.

Light rays from the target object passing through the offset double-sided lens sheet 1700A and the in-line double-sided lens sheet 1700B is refracted and/or reflected in angles substantially reducing the visibility of the target object or its shadow.

In this arrangement, in contrast to the embodiment of FIG. 3C, an object 1702 at a particular distance d, when viewed at location 1710 will not appear in the mirror image. Due to the polarization and placement of the sheets 1700A, 1700B the effect is to reflect or refract light rays by the back-to-back plurality of lenses 1706, 1707 such that the object 1702 is observed in the correct orientation.

Objects of any polarity can be removed or reduced in visibility by shifting the angle and removing the object (and surrounding background) out of the field of view or by utilizing the neutral sections objects of the same polarity can be reduced or removed from view which will be discussed with reference to FIGS. 20. 21, 22. Objects of the opposing polarity may also be removed or reduced in visibility if their width can be hidden in these neutral sections. While FIG. 17 shows the plurality of lenses 1706, 1707 running horizontally, the plurality of lenses may also run vertically or at an angle and still achieve target concealment. In another embodiment, a sheet similar to sheets 1700 containing the plurality of lenses may be curved to make the target concealment region larger.

The embodiment of FIG. 17A has been found to have the similar effect as the embedment of FIG. 16 even though in the embodiment of FIG. 17A, corresponding lenses 1714, 1715 of lens sheets 1700A, 1700B respectively, are in an external offset relationship.

FIG. 17B shows two double-sided lens sheets disposed in close proximity, depicted as a first sheet 1700C, and a second sheet 1700D (collectively sheets 1700′) exemplary of another embodiment of the present invention. The embodiment of FIG. 17B is similar to the embodiment of FIG. 17A except that both double-sided lens sheets 1700C, 1700D have corresponding lenses on opposite sides arranged in an offset relationship. That is, in the embodiment of FIG. 17B, it can be seen that on both sheets corresponding lenses on opposite sides of sheets 1700C, 1700D (e.g., lens 1706′ and lens 1707′) are arranged in a staggered manner having an offset relationship to one another. This is in contrast to the embodiment of FIG. 17A where only the 1700A has the offset relationship whereas sheet 1700B has an in-line arrangement.

A method of target concealment and shadow reduction using the embodiment of FIG. 17B involves placing these two double-sided lens sheets 1700′, each having lenses on both sides, between a viewer and the target object to be concealed. This embodiment has been found to have the same effect as the embedment of FIG. 16.

Corresponding lenses 1714′, 1715′ on the double-sided lens sheets 1700C, 1700D respectively may be at different distances relative to a common bottom and may thus be externally offset or staggered. Of course, in vertically polarized embodiments where lenses are disposed vertically, corresponding vertical lenses on opposite sides of the in-line double-sided lens sheet would be the same level or height relative to left or right of the sheet.

This embodiment also has the advantage of presenting the background scene behind an object to be concealed correctly, without creating a mirror image.

Light rays from the target object passing through the offset double-sided lens sheets 1700C, 1700D is refracted and/or reflected in numerous directions substantially reducing the visibility of the target object or its shadow.

In this arrangement, in contrast to the embodiment of FIG. 3C, an object 1702′ at a particular distance d, when viewed at location 1710′ will not appear in the mirror image. Due to the polarization and placement of the sheets 1700C, 1700D the effect is to reflect or refract light rays by the back-to-back plurality of lenses 1706′, 1707′ such that the object 1702′ is observed in the correct orientation.

### EMBODIMENT 2.10—TWO IN-LINE DOUBLE-SIDED LENS SHEET ALIGNED

FIG. 18 shows two double-sided lens sheets disposed in close proximity, depicted as a first sheet 1800A, and a second sheet 1800B (collectively sheets 1800) exemplary of another embodiment of the present invention. A method of target concealment and shadow reduction using the embodiment of FIG. 18 involves placing these two double-sided lens sheets 1800, each having lenses on both sides, between a viewer and the target object to be concealed. This embodiment has also been found to have a similar effect as the embodiment of FIG. 16 with different angles.

In the embodiment of FIG. 18, it can be seen that corresponding lenses on opposite sides of the offset double-sided lens sheet 1800A (e.g., lens 1812 and lens 1814) are aligned without an external offset. Corresponding lenses on opposite sides of the double-sided lens sheet 1800A, 1800B are arranged to line up with one another.

Corresponding lenses on opposite sides of on the in-line double-sided lens sheet 1800A, 1800B are thus at the same distance relative to the top or bottom of the sheet. Of course, in vertically polarized embodiments where lenses are disposed vertically, corresponding vertical lenses on opposite sides of the in-line double-sided lens sheet would be the same level or height relative to left or right of the sheet.

This embodiment has the advantage of presenting the background scene behind an object to be concealed correctly, without creating a mirror image.

In this arrangement, in contrast to the embodiment of FIG. 3C, an object 1802 at a particular distance d, when viewed at location 1810 will not appear in the mirror image. Due to the polarization of the sheets 1800A, 1800B the effect is to reflect or refract light rays by the back-to-back plurality of lenses 1806, 1807 such that the object 1802 is observed in the correct orientation.

Objects of the same polarity can be removed or reduced in visibility by utilizing the neutral sections, which will be discussed with reference to FIGS. 20, 21, 22. Objects of the opposing polarity may also be removed or reduced in visibility if their width can be hidden in these neutral sections. While FIG. 18 shows the plurality of lenses 1806, 1807 running horizontally, the plurality of lenses may also run vertically or at an angle and still achieve target concealment. In another embodiment, a sheet similar to sheets 1800 containing the plurality of lenses may be curved to make the target concealment region larger.

This embodiment of FIG. 18 has been found to have the similar effect as the embedment of FIG. 16 with different angles, even though in the embodiment of FIG. 18. corresponding lenses 1814, 1815 of lens sheets 1800A, 1800B respectively, are in an external offset relationship.

### EMBODIMENT 2.11—TWO IN-LINE DOUBLE-SIDED LENS SHEET WITH AN EXTERNAL OFFSET

FIG. 19 shows two double-sided lens sheets disposed in close proximity, depicted as a first sheet 1900A, and a second sheet 1900B (collectively sheets 1900) exemplary of another embodiment of the present invention. A method of target concealment and shadow reduction using the embodiment of FIG. 19 involves placing these two double-sided lens sheets 1900, each having lenses on both sides, between a viewer and the target object to be concealed. This embodiment has also been found to have the same effect as the embodiment of FIG. 16 with different angles.

In the embodiment of FIG. 19, it can be seen double-sided lens sheets 1900A, 1900B have an external offset, that is, corresponding lenses (e.g., lens 1915 and lens 1914) are offset so that they are not aligned.

Corresponding lenses on opposite sides of the same lens sheet 1900A (or within lens sheet 1900B) are at the same distance relative to the top or bottom of the sheet. Of course, in vertically polarized embodiments where lenses are disposed vertically, corresponding vertical lenses on opposite sides of the in-line double-sided lens sheet would be the same level or height relative to left or right of the sheet.

This embodiment also has the advantage of presenting the background scene behind an object to be concealed correctly, without creating a mirror image.

In this arrangement, in contrast to the embodiment of FIG. 3C, an object 1902 at a particular distance d, when viewed at location 1910 will not appear in the mirror image. Due to the polarization of the sheets 1900A, 1900B the effect is to reflect or refract light rays by the back-to-back plurality of lenses 1906, 1907 such that the object 1902 is observed in the correct orientation.

Objects of the same polarity can be removed or reduced in visibility by utilizing the neutral sections, which will be discussed with reference to FIGS. 20, 21, 22. Objects of the opposing polarity may also be removed or reduced in visibility if their width can be hidden in these neutral sections. While FIG. 19 shows the plurality of lenses 1906, 1907 running horizontally, the plurality of lenses may also run vertically or at an angle and still achieve target concealment. In another embodiment, a sheet similar to sheets 1900 containing the plurality of lenses may be curved, making the target concealment region larger.

This embodiment of FIG. 19 has been found to have the similar effect as the embedment of FIG. 16 with different angles even though in the embodiment of FIG. 19, corresponding lenses 1914, 1915 of lens sheets 1900A, 1900B respectively, are in an external offset relationship.

In operation, all of the embodiments depicted in FIGS. 3C, 14, 15, 16, 17A, 17B, 18, and 19 can be characterized by the ability to create merged repeating images from a viewer's perspective.

An example is illustrated in FIG. 20. A lens sheet 2002 is disposed between a background scene 2010 that depicts a flagpole 2006 and a viewer. The image viewed through sheet 2002 is formed by merging repeating portions of the background scene 2010. The flagpole 2006 is not visible at the expected location within the viewed image, which is made up of a plurality of neutral sections 2004, and repeating sections 2008.

In order to achieve this repeating pattern, in one specific embodiment, two different types of lenses are used back to back in sheet 2002 where the lenticules have different viewing angles, one with forty-two degrees (42°) and the other with thirty degrees (30°). Viewing angles are conceptually illustrated in FIG. 2.

This lenticules arranged in this manner, create a series of duplicate or repeating sub-images each with a slightly different perspective of the same background. The repeating sub-images are blurry views of composed of the left and right side of the viewable image, merging at locations that are about an inch or two in width, and identified in FIG. 20 as neutral sections 2004. These neutral sections 2004 are merging areas of the far left and far right of these sub-images that repeat.

A target object in the neutral section 2004 would be hidden from view. This is more clearly illustrated in FIG. 21 and FIG. 22.

FIG. 21 depicts a lens sheet 2102 made of one or two double-sided lens sheets, disposed between a background scene 2106 and a viewer. The lenticular lenses used are of the same LPI and same viewing angle on either side. The image viewed through sheets 2102 is formed by merging together portions of the background scene 2002. The viewed image contains a neutral section 2104. If a target object such as a hand is brought very close to the lens sheet 2102, it will be partially visible as a hand image 2108. However, as depicted in FIG. 22, the hand will be hidden in the neutral section 2204 when the hand is moved away from the lens sheet.

FIG. 22 depicts a lens sheet 2202 disposed between a background scene 2206 and a viewer. The image viewed through sheet 2202 is formed by merging together portions of the background scene 2202. The viewed image contains a neutral section 2204. Here, the target object (e.g. hand) is kept away from the lens sheet 2202, and thus it is hidden within the neutral section 2204.

The material of lens sheet 2202 does not need to be offset in order to achieve these repeated sub-images. A similar effect of repeating sub-images can thus be realized using embodiments depicted in FIG. 16, or FIG. 17A or FIG. 18 or FIG. 19.

It should be noted that in relation to the embodiments of FIGS. 3C, 14, 15, 16, 17, 18, 19, the depictions of FIGS. 20-22 (where the sub-images repeat in the vertical direction) are best understood as overhead views.

Otherwise, in embodiments where lenses are disposed horizontally, these sub-images would be repeating horizontally instead, stacked over another, so that for example, the sky in one sub-image will be shown below, the ground in an adjacent sub-image.

Many versions of variations of the above embodiments in unique sub-combinations will be discussed below.

### Version 1

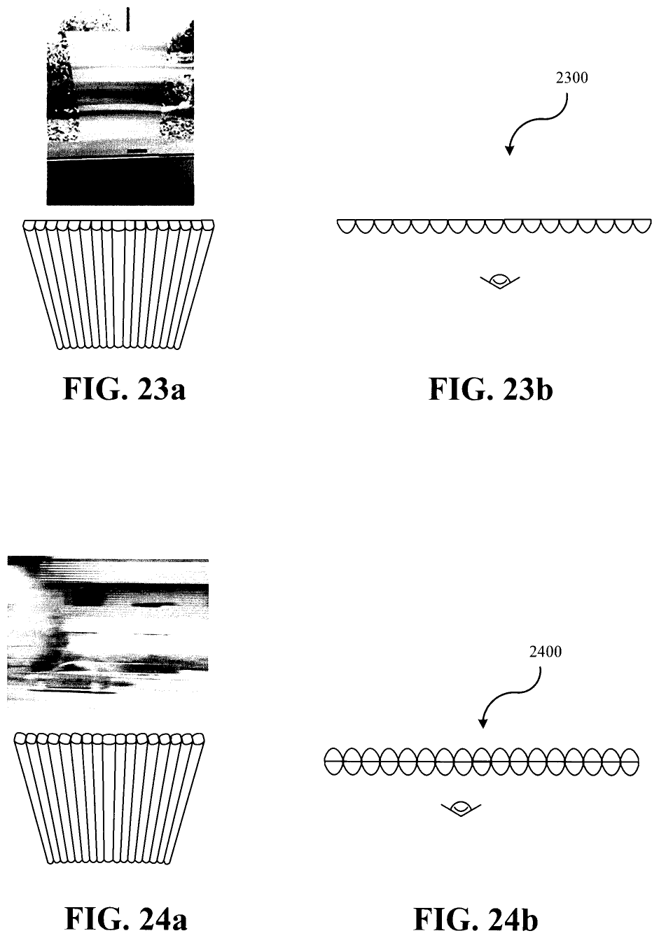

FIGS. 23a-23b are simplified schematic diagrams of an elevation view and plan view, respectively of a single-sided lens sheet disposed between an observer and a background. The background here is blurry.

### Version 2

FIGS. 24a-24b are simplified schematic diagrams of an elevation view and plan view, respectively of a double-sided lens sheet disposed between an observer and a background. The background seen through this lens sheet has a mirror image orientation, which also makes it sensitive to the movement of the observer.

### Version 3

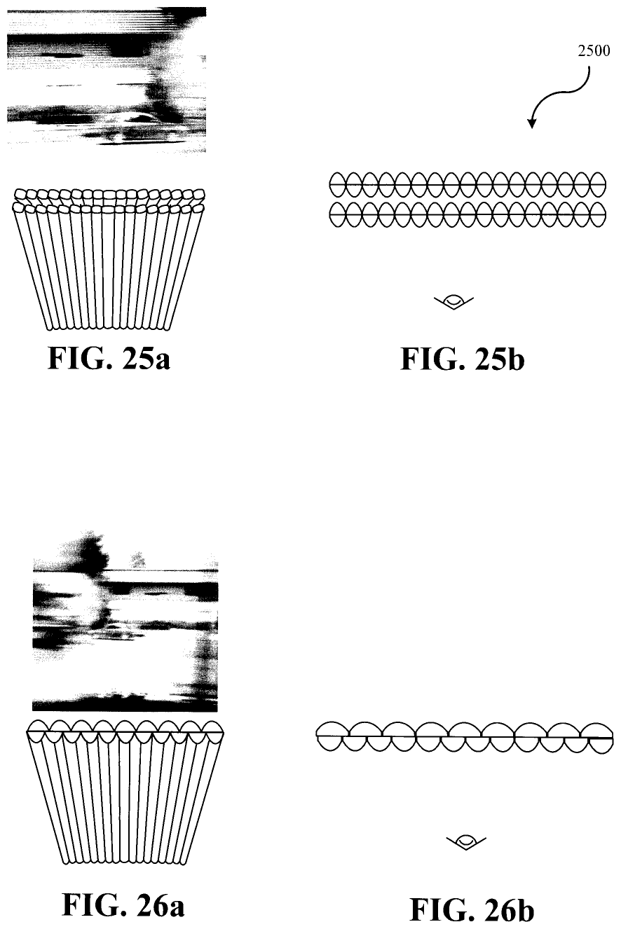

FIGS. 25a-25b are simplified schematic diagrams of an elevation view and plan view, respectively of two double-sided lens sheets disposed between an observer and a background. The background seen through this lens sheet also has the correct orientation and matches to movement of the observer.

### Version 4

FIGS. 26a-26b are simplified schematic diagrams of an elevation view and plan view, respectively of a double-sided lens sheet disposed between an observer and a background where the two sides have different LPI. The larger lens (e.g. 75 LPI) is close to the target while the smaller lens (100 LPI) is closer to the viewer. The viewed image has a mirror image orientation but a wider field of view than the lens sheet of FIGS. 24a-24b.

### Version 5

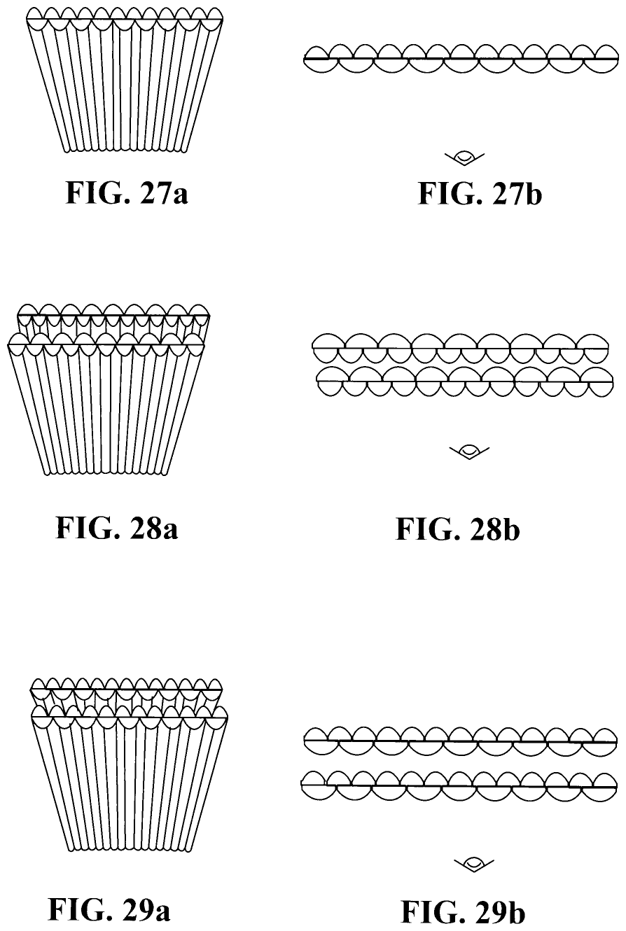

FIGS. 27a-27b are simplified schematic diagrams of an elevation view and plan view, respectively of another double-sided lens sheet disposed between an observer and a background where the two sides have different LPI. The larger lens (e.g. 75 LPI) is close to the viewer while the smaller lens (100 LPI) is closer to the target. This view in embodiment is in the correct orientation but characterized by a smaller field of view than FIGS. 25a-25b and sensitive to the movement of the observer. This version can be curved towards the viewer to compensate for multiple image artifacts. If the viewer gets too close to the lens sheet the image will flip into the correct orientation as they hit the convergence zone of the light rays on the viewer's side of the lens sheet.

### Version 6

FIGS. 28a-28b are simplified schematic diagrams of an elevation view and plan view, respectively of two double-sided lens sheets disposed between an observer and a background where the two sides of each sheet have different LPI. This is equivalent two of the embodiments in FIGS. 26a-26b disposed proximate one another. The lenses in each sheet on the side of the viewer may be smaller (e.g., 100 LPI) while the lenses in each sheet on the side of the background or target may be larger (e.g., 75 LPI). The background seen through this lens sheet also has the correct orientation and matches the movement of the observer.

### Version 7

FIGS. 29a-29b are simplified schematic diagrams of an elevation view and plan view, respectively of two double-sided lens sheets disposed between an observer and a background where the two sides of each sheet have different LPI. This is equivalent two of the embodiments in version 5 disposed proximate one another. The lenses in each sheet on the side of the viewer may be large (e.g., 75 LPI) while the lenses in each sheet on the side of the background or target may be smaller (e.g., 100 LPI). In this version correct orientation, correct perspective may be achieved without multiple image artifacts.

### Version 8

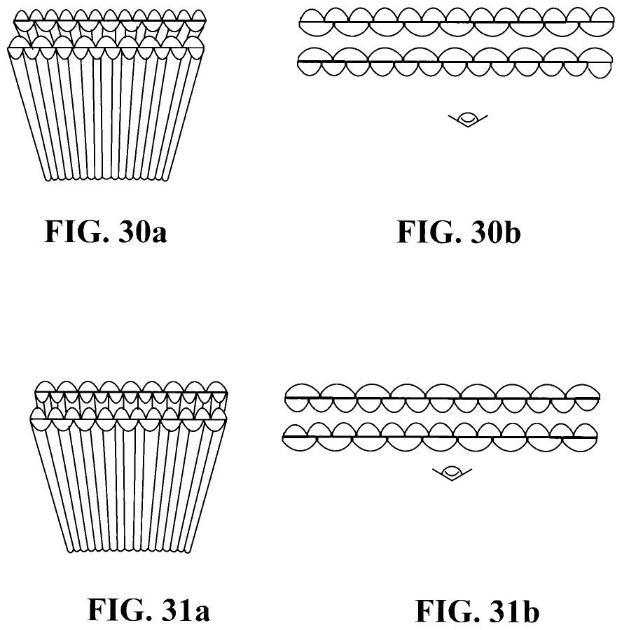

FIGS. 30a-30b are simplified schematic diagrams of an elevation view and plan view, respectively of two double-sided lens sheets disposed between an observer and a background where the two sides of each sheet have different LPI. The outer lenses are small (e.g. 100 LPI) while the inner lenses are larger (e.g., 75 LPI). This version displays mirror image orientation and may display multiple images. This version cannot be curved to compensate for mirror image or multiple (repeating) artifacts.

### Version 9

FIGS. 31a-31b are simplified schematic diagrams of an elevation view and plan view, respectively of two double-sided lens sheets disposed between an observer and a background where the two sides of each sheet have different LPI. The inner lenses are small (e.g. 100 LPI) while the outer lenses are larger (e.g., 75 LPI). This version may display multiple images. This version cannot be curved to compensate for multiple image artifacts but shows correct image orientation.

### Base Lens and Sub-Lens Configurations

In addition to the embodiments depicted above, other exemplary embodiments of the present invention include lens sheets with sections having lenses of a different polarity or angle or LPI. The term “sub-lens” is used to represents any part of the lens that differs from the LPI wide/narrow angle and/or overall angle/polarity of the base lens as shown in FIG. 32. All lenses referenced may be manufactured as one piece.

Lens sheets may be manufactured to have various polarities within the same lens sheet even for single-sided lens sheets, as depicted in FIG. 32 to FIG. 41.

Although the sub-lens are shown slightly off horizontal in some of the exemplary embodiments, any other angle and/or different size lenses within different shapes may be used to mimic camouflage.

As background color matching with static camouflage is nearly impossible due to changing locations, changing environments, changing seasons and changing times of day, these embodiments allow the material to match the background colors as any of the variables change.

FIG. 32 is a simplified perspective view of a single-sided lens sheet 3200 having a vertical polarity whereby the lenses are disposed vertically. These lenses may be referred to as base lenses.

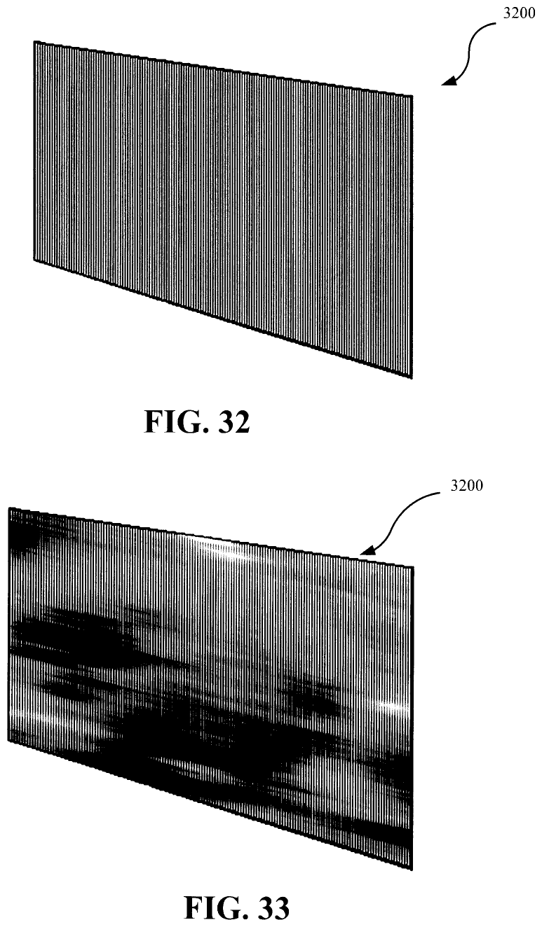

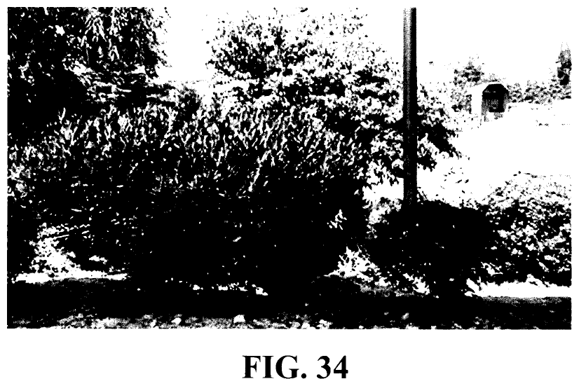

When a background image is viewed through the lens sheet 3200 of FIG. 32, then the resulting image viewed may be as represented as shown in FIG. 33 depicting a blurred background image. The actual background is shown in FIG. 34.

### Version 10

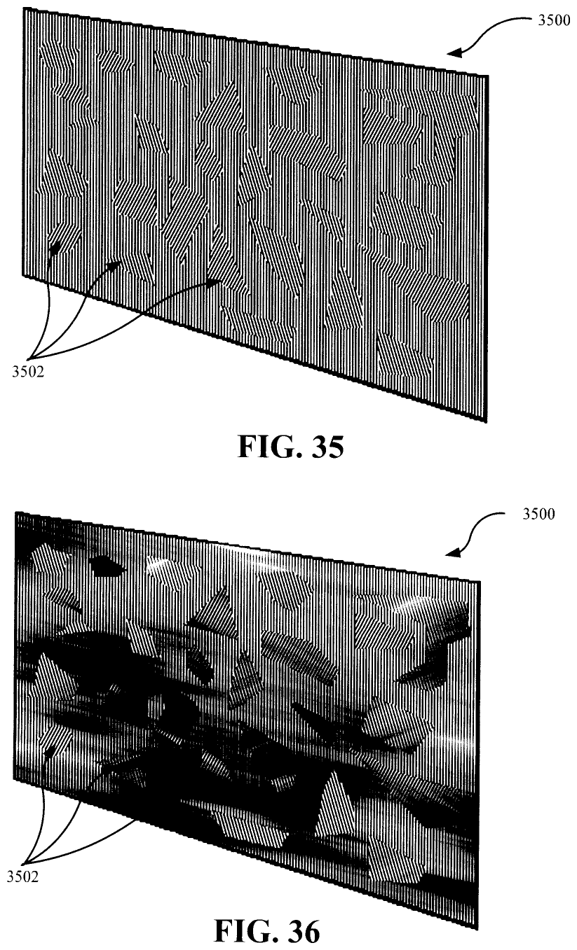

FIG. 35 is a simplified perspective view of a single-sided lens sheet 3500 having base lenses of a vertical polarity and further having several angled sections 3502 of sub-lenses whereby the sub-lenses within the angled sections are disposed at an angle or different angles (referred to herein as Version 10).

FIG. 35 thus represents a one sided lenticular lens of base lenses in the vertical polarization, with two different angles in different geometric shapes for the sub-lenses. In the depicted embodiment, one angle of the sub-lenses in sections 3502 is slightly left of vertical and appears on about half of the shapes while the other is slightly right of vertical. This may be done painstakingly, often with some difficulty, after the manufacturing process. Conveniently, it is more easily done during manufacturing where the lens material is molded from a drum whereby the mold would have all the different lens angles formed thereon.

FIG. 36 is a simplified perspective view of the lens sheet 3500 of FIG. 35 depicting a blurred background image having different types of artifacts caused by the corresponding angled sections 3502. This has a similar effect to camouflage, to break up the background so the lens material is not perceived as an anomaly to a viewer. Unlike static camouflage where the colors are predetermined, the added benefit of this embodiment is that it is that all the lenses are dynamically made up of surrounding colors of the background.

### Version 11

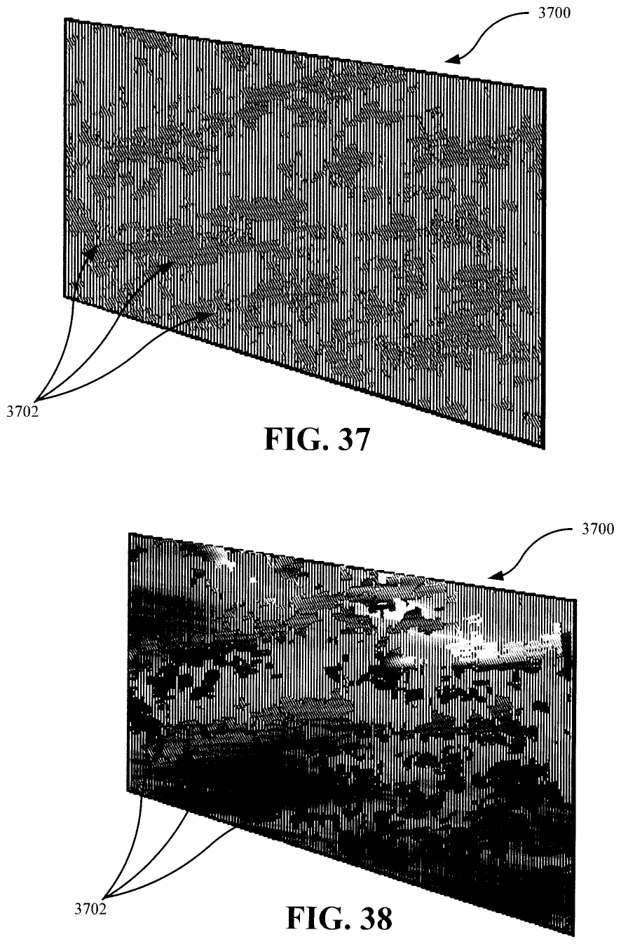

FIG. 37 is another simplified perspective view of a single-sided lens sheet 3700 having base lenses of a vertical polarity and further having several angled complex sections 3702 of sub-lenses whereby the sub-lenses within the angled complex sections are disposed at an angle (referred to herein as Version 11). This embodiment better represents more natural geometric shapes, for use in outdoor, woodland backgrounds. Although a single angle is used for the arrangement of the sub-lenses in sections 3702 for the pattern, more than one angle may be used to increase the realism. In addition, lens sheets other than single-sided lens sheets may be utilized.

FIG. 38 is a simplified perspective view of the lens sheet of FIG. 37 depicting a blurred background image having different types of artifacts caused by the corresponding complex sections; and represents how the specially manufactured lens sheet 3700 and portrays the background. This has a similar effect to camouflage, to break up the background so the material does not appear to be an anomaly to the viewer. Unlike static camouflage where the colors are predetermined, the added benefit here is that it is that all the lenses are still pulling surrounding colors of the background.

### Version 12

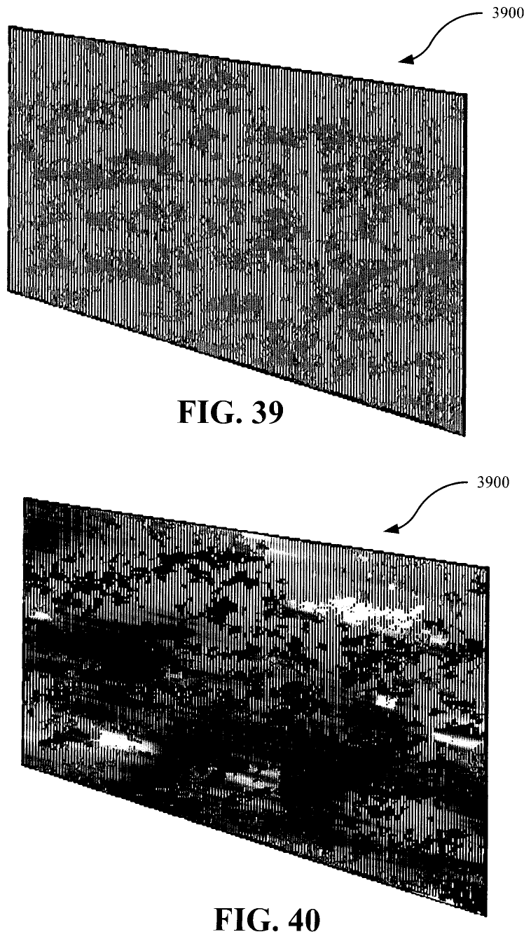

FIG. 39 is a simplified perspective view of a single-sided lens sheet 3900 having base lenses of a first characteristic (e.g., a first LPI) and further having several sections of sub-lenses (referred to herein as Version 12). The base lenses and sub-lenses are both disposed vertically but the sub-lenses within the sections have a second characteristic (e.g., a second LPI), which is different from the first characteristic (e.g., the second LPI is different from the first LPI). By utilizing the differences between different LPIs to achieve a similar effect to angled arrangement of the sub lenses.

In FIG. 39 the first characteristic for the base lenses may be a narrow-angle while the second characteristic for sub-lenses may be wide-angle lenses of the same LPI. Conversely, the first characteristic for the base lenses may be a wide-angle while the second characteristic for sub-lenses may be narrow-angle lenses of the same LPI. Again, utilizing the differences between narrow-angle and wide-angle lenses of the same LPI, the same effect or a similar effect to angled arrangement of the sub lenses is achieved.

As noted above, the sub-lenses may be of a different LPI or a different angle of the base lens. There may be more than one sub-lens with different LPI and/or different angles.

FIG. 40 is a simplified perspective view of the lens sheet of FIG. 39 depicting a blurred background image having different types of artifacts caused by the corresponding sections.

FIG. 41 is a simplified elevation view of the lens sheet of FIG. 39 placed in front of a background depicting improved concealment. The simulated representation of the lens sheet of FIG. 39 into the background depicts black vertical for illustration of the polarity only. Such lines would not be discernable to the viewer and the embodiment provides improved concealment.

The patterns used on the sub-lenses to disrupt the background may be specific to environment. For urban environments, angles representative of walls, floors, or stairs may be used. For arid deserts, sparse disruption conducive to such environments would be used. For snow environments, patterns that simulate those shapes found in the snow environment would be used.

Manufacturing different patterns within a lenticular lens is known. The present embodiments may be made using known manufacturing techniques. While known manufacturing techniques utilize the lens material directly on top of images, embodiments of the present invention portray the background and hide a target.

### EMBODIMENT 3.1 MAKING A DOUBLE-SIDED LENS SHEET (PERMANENT BONDING)

As noted above, a double-sided lens sheet may be constructed from a pair of single-sided lens sheets. The double-sided lens sheet may be constructed by permanently or temporarily bonding, gluing or otherwise affixing together, the smooth sides of a pair of single-sided lens sheets back to back. Additionally, in some embodiments that will be described below, temporary bonding elements added between the smooth or flat surfaces of each single-sided lens sheet to improve visibility of the double-sided lens sheet.

### EMBODIMENT 3.2 MAKING A DOUBLE-SIDED LENS SHEET (ADDING WATER)

In a variation of the above method of constructing a double-sided lens sheet, the inventor has found that adding water between the smooth sides of a pair of single-sided lenticular lens has been found create a suitable temporary or movable bond. The water creates a suitable bond that allows movement of the two single-sided lens sheets relative to one another with some opposing pressure. Advantageously, adding water has been found to improve clarity when viewing the background through the double-sided lens sheet.

An added second advantage of adding water between two lens sheets is that the water allows adjustment of the offset distance Δx as described with reference to FIG. 15. This feature thus allows an in-line double-sided lens sheet without an offset (where offset distance Δx=0), to be converted or turned into a double-sided lens sheet with an offset (where 0<Δx<H), and vice versa.

Adding water further has the advantage of providing an ability to use two lenticular sheets and easy vary the angle between the two to produce a resonance wave pattern, which further disrupts viewing of the target. While this technique works above water, it may be a requirement to hide a target underwater where the refraction of water can negate or cancel the effect of refraction the lens.

### Version 13

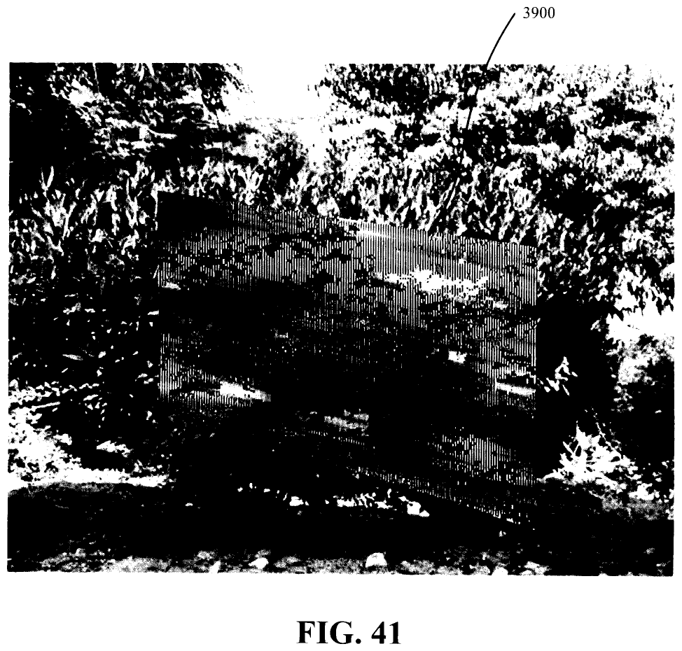

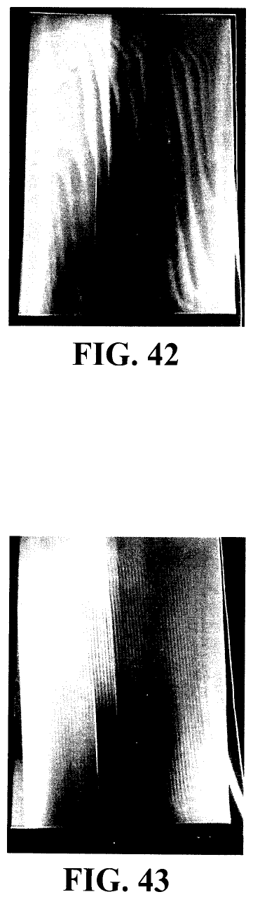

FIG. 42 and FIG. 43 depict two images with two single-sided lens sheets with both lenses running horizontally, left to right. Varying the angle just off center as shown in FIG. 42 it can be seen that the interference pattern between the two creates a large disruptive element vertically. Embodiments of lens sheet arrangements depicted in FIGS. 42-45 will be referred to herein as Version 13. Varying the angle of the top piece even further off center the interference pattern is quite tight in comparison as shown in FIG. 43.

A single piece of lens sheet on the surface of water has the ability to hide the diver below. However, if the lens sheet is submerged, it may allow a viewer see right through at the diver below. As the refraction of light in water changes the angle of light that the lens can refract. The object may still be hidden in the same way as it is above water with a single lens or any other method described here but the distance between the target to hide and the lens may be longer under water due to the extra refraction element of the water on the light rays. This also applies to reduction of shadows produced by a target under water and a light source in or above the water where the lens is between the light source and the target.

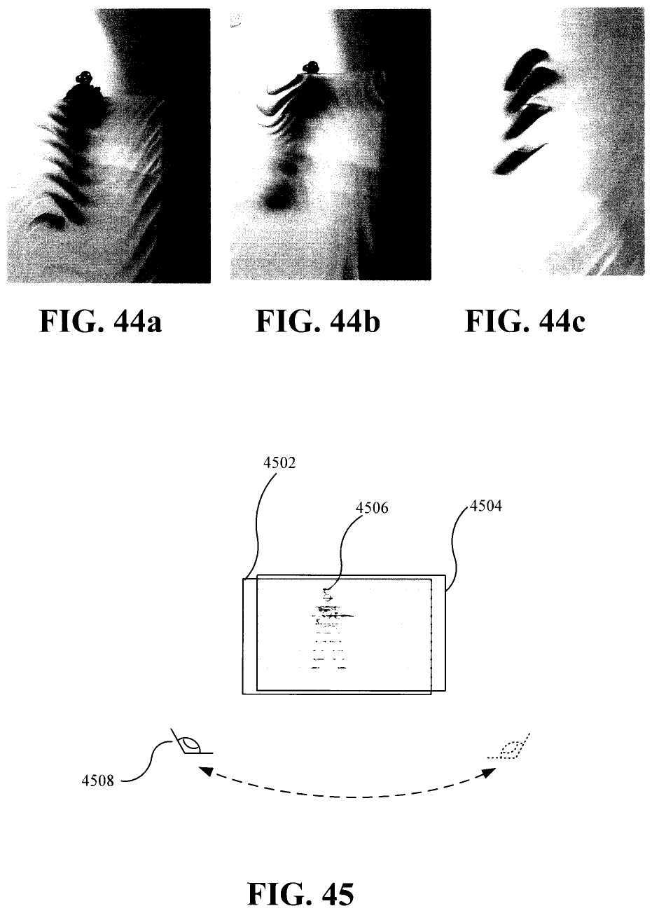

In other embodiments, two lens sheets may be placed back-to-back or front-to-back or front-to-front in the same polarity (left to right) and both may be submerged. By adjusting the angle between the two, diffident concealing or camouflaging effects can be observed, utilizing the interference pattern as shown in FIG. 44a, FIG. 44b and FIG. 44c. When the polarizations converge, a target diver may be seen through both pieces of lens sheet material. Distorting the view to such an extent that a viewer cannot identify the target is highly beneficial.

Varying distortions, based for example on the degree of offset between the lens sheets, can produce very different results. For example, the image shown in FIG. 44c does not resemble a human outline or shape.

In yet another embodiment depicted in FIG. 45, using two lens sheets 4502, 4504 of the same polarity are used back to back but with a slight offset in the angle between the two sheets. This causes the target 4506 to be partially visible at different perspective locations of viewer 4508 and invisible at other angles. Determining what the target 4506 is may be difficult at best. The distortion could also hinder correctly aiming at the target 4506.

### EMBODIMENT 3.3 MAKING A DOUBLE-SIDED LENS SHEET (INTEGRAL SINGLE PIECE)

In other embodiments, a double-sided lens sheet may be constructed or manufactured integrally as a single piece. This may have advantages of durability and strength in use.

While both the lens sheets 2300, 2400 of FIG. 23a and FIG. 24a respectively utilize the same type of material, the effect on the trajectory of light rays are different leading to different ways of hiding the target. Lens sheet 2300 refracts the light, which created a dead zone in the middle where a target could be placed and hidden almost completely from an observer on the other side. In a low-density background this works extremely well, in a high-density background with lots of detail, it creates a smear running either horizontal or vertical depending on the orientation of the lens, which can cause the material to standout and draw attention within the background.

Lens sheet 2400 of FIG. 24a overcomes this drawback by providing the shapes and some of the higher details in the background on the lens sheet 2400 while still removing the target from the viewer on the opposite side; however, the image of the background is mirror image.

Lens sheet 2500 of FIG. 25a corrects the mirror image drawback of lens sheet 2400 to the correct orientation by simply using a second lens sheet 2400 in front or behind the first. There is a slight reduction of image quality between lens sheet 2400 and lens sheet 2500, most of which can be improved with manufacturing.

Lens sheet 2400 is shown as one piece but could be two separate single-sided lenses bonding the smooth side of the lenses together. This would apply also to the material within lens sheet 2500, which is simply two of lens sheet 2400 in front of each other.

In FIG. 25a, lens sheet 2500 may cause ripple distortions due to the loose gap between the pair of individual single-sided lens sheets (similar to lens sheet 2400) that make it up. Bonding of the individual lens sheets may be used to prevent or reduce ripples.

Lens sheet 2500 allows for correct orientation, proper shapes and correct perspective when the viewer moves around, compared to lens sheet 2400 (mirror image). However, the object to be hidden from the viewer is now visible through lens sheet 2500. There are two solutions for this problem. The first is to offset one of the two double-sided lens sheets as shown in FIG. 16, FIG. 17a or FIG. 17b. That is, one offsets one of the two single-sided lens sheets making up one of the double-sided lens sheets, relative to each other. This allows shifting the image right or left, remove a target object from the field of view of the viewer.

Depending on the lens configuration, the LPI (lenses per inch) and the angle of the lens, one can hide a target in another way with both lens sheets 2400, 2500. This may be done by adjusting the offset, moving one lens left or right of the second lens in lens sheet 2400. Note that in the area where a target object image would be present, there is instead a blurry image of the background. This occurs as the material is merging the far right and far left of the viewable background, this is why there seems to be half a tree on the far left of the material. This image will repeat in the material depending on the LPI and angle. This allows placement of objects to be hidden within a neutral merge zone.

While lens sheet 2400 can utilize the mirror image flip point (location 1310 in FIG. 3C) to hide an object within the zone, lens sheet 2500 cannot. Lens sheet 2500 can however, utilize offsetting the background to hide a target or place the target in the merge zone of the image. Setting the merging zone can be accomplished by moving the offset left or right of the second piece of material with both lens sheet 2400 and lens sheet 2500, and it does not need to be set in the center region of the material.

Adding water between the two pieces of single-sided lens sheet 2300 to make up lens sheet 2400 provides the clarity through the material that would be difficult to achieve without it. Water also helps simulate the two pieces being manufactured as one piece or two pieces bonded together and provides the ability to move the each of the two single-sided lens sheets separately with some opposing pressure on each piece for experimentation.

### Masking Movement of Target Objects

Among the advantages of some embodiments of the present invention is the ability of the lens sheet material to mask movement of moving or mobile objects behind the lens sheet from the viewer, in addition to camouflaging or hiding the objects themselves.

This is an advantage over the use of static camouflages, whose ability to conceal target objects is often limited when the objects are mobile. Even the best static camouflage is limited, when an object moves, as the movement presents an anomaly or aberration to the viewer, which lends an element of detection and helps in recognizing the target. Focal vision is better able to determine details versus ambient vision. When configured correctly a lens sheet masks most or all visual cues associated with the movement of the target.

The inventor has found that a riot shield with a piece of lenticular lenses running vertically can hide most of the target that is covered.

### Riot Shield Embodiment

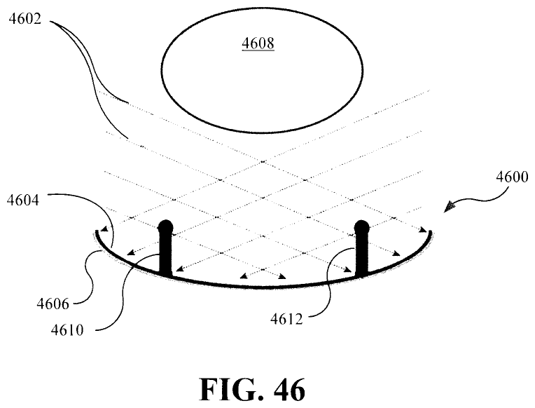

An exemplary embodiment of the present invention include riot shields. FIG. 46 depicts a riot shield 4600 having a clear shield body 4604 and a lens sheet 4606 disposed thereon.

In such an embodiment where there is a short distance between the person holding the shield using handles 4610, 4612 and the clear shield body 4604, lens sheet 460 on the clear riot shield body provides camouflage that depicts more of the background and hides an object 4608 in the form of the person holding the shield 4600.

The reason lens sheet 4606 on the riot shield 4600 shows the background well is that the lens polarization is vertical, which hides a person with a vertical aspect ratio, having a longer height than width, behind while retaining the horizontal elements such as horizontal edges. Lens sheet 4606 refracts the horizontal and hides the vertical.

Longer handles and/or a lenticular lens with a greater angle would improve the effect. The greater angle in the lens could allow the target to be closer without being seen.

Lens sheet 4606 in riot shield 4600 is similar to lens sheet 2300 of FIG. 23b, sometimes referred to as version 1 in this disclosure. However, other versions such as lens sheet 2500 of FIG. 25b (sometimes referred to as version 3) may be used instead and may be more effective, increasing background detail visible through the lens sheet material and helping to reduce, minimize or even eliminate lens flare, which occurs with lens sheet 2300 when a very bright light source is behind it.

### Vehicle Windows

In addition to riot shields, a lens sheet such as lens sheet 4606 may find application on car windows of vehicles transporting one or more dignitaries or important guests in the back. From outside there is no one visible in the back seat although the windows having a lens sheet overlaid thereon appear clear or only slightly tinted windows. In contexts where tinting of windows is not permitted, due to prohibition, law, regulation or custom, important dignitaries traveling in vehicles would be highly visible and vulnerable.

### Avoiding Aerial Mobility Detection—Umbrellas

A simple yet effective exemplary method of hiding a target on ground from aerial detection by cameras, aircraft, or drones above while maintaining mobility involves the use of an umbrella with exemplary lens sheet material in one of the versions or embodiments described above.

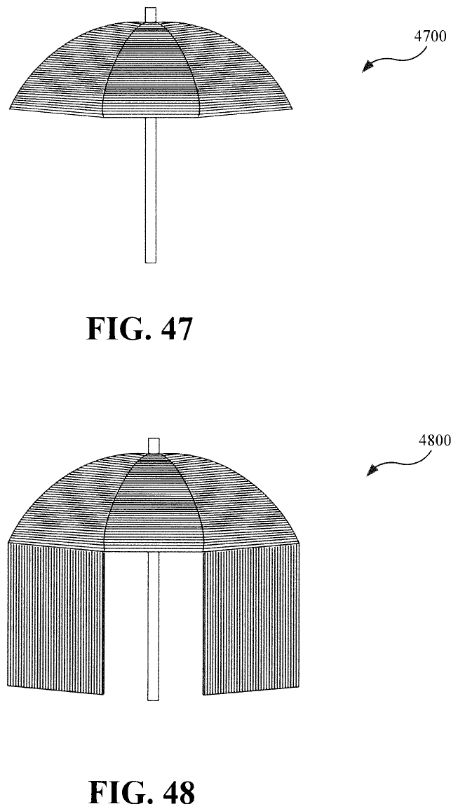

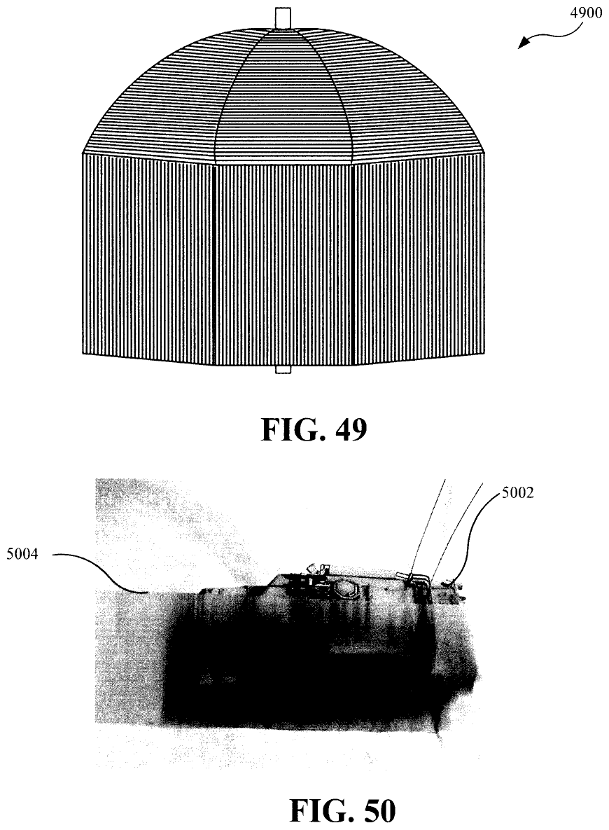

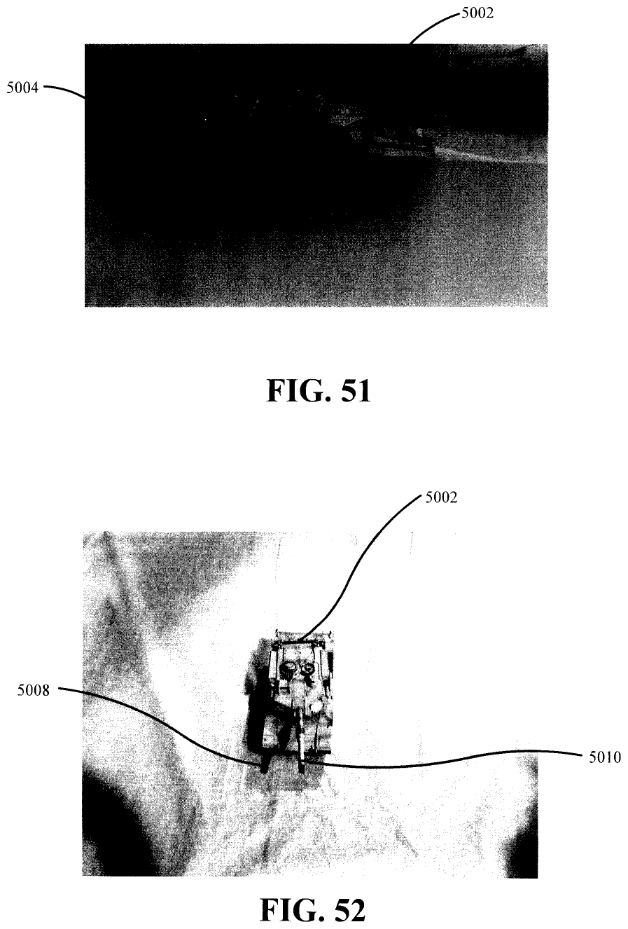

FIG. 47, FIG. 48, and FIG. 49 depict exemplary embodiments of such umbrellas in the form of umbrella 4700, umbrella 4800, and umbrella 4900, respectively. As may be seen in FIG. 50 and FIG. 51 such an umbrella provides the colors of the background or ground while masking the movement of the target object 5002 that would not be detected unless observed from a different angle to view the body the target below the umbrella.

Such umbrella or umbrella-like embodiments mask the identity of the target object which may include a person and his or her critical equipment that is sufficiently high to be hidden, such as on the back of the person.

Of course, larger umbrellas mask greater areas and a modified umbrella that uses lens sheet material that came down near the ground such as umbrella 4800 of FIG. 48 can hide the entire person even from side views or angled viewing positions.

In the embodiment depicted in FIG. 50, a lens sheet 5004 may be a single-sided lens sheet similar to lens sheet 2300. As will be apparent to the skilled reader, other embodiments of exemplary lens sheets described above may also be used to avoid aerial detection of moving persons or equipment. Lens sheet 5004 may be scaled to provide aerial cover or camouflage for much larger objects. FIG. 51 depicts another view of the camouflaging of target object 5002 by a lens sheet 5004.

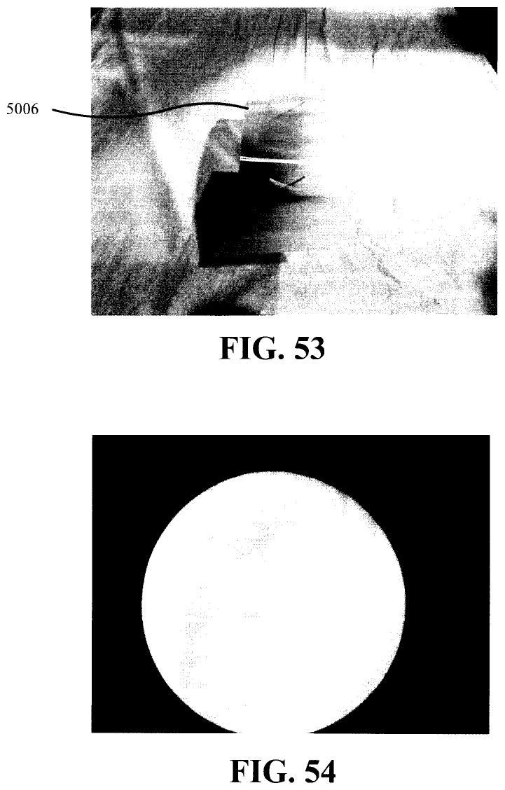

FIG. 52 depicts the target object 5002 in the form of a tank, which casts a shadow including a shadow 5008 of the barrel 5010 of the tank. FIG. 53, depicts the same target object 5002 in the form of a miniature tank model under a lens sheet 5006. Lens sheet 5006, in this embodiment, is made of the same lens material such as lens sheet 5004 and is used to protect the tank from aerial detection while in motion.

Lens sheet 5006 is placed over the tank and but may be affixed at a sufficiently elevated position to allow enough standoff distance to obscure the tank from overhead threats. To elevate lens sheet 5006 a suitable longitudinal support is used.

Any movement of object 5002 results in minimal anomaly or artefact, and thus the moving object is well hidden from detection overhead. An antireflective coating on lens sheet 5006 reduces light reflection further. Shadow 5008 of the barrel of the gun 5010 visible in FIG. 52, for the tank is also no longer clearly visible in FIG. 53. The image of FIG. 53 is taken with about sixteen (16) halogen light sources in the room and thus with just one light source such as the sun, the result would be an even fainter shadow, if detectable at all.

FIG. 54 depicts a photograph of the embodiment shown in FIG. 53 using a military grade night vision equipment showing that the effect also works a large range of the electromagnetic spectrum.

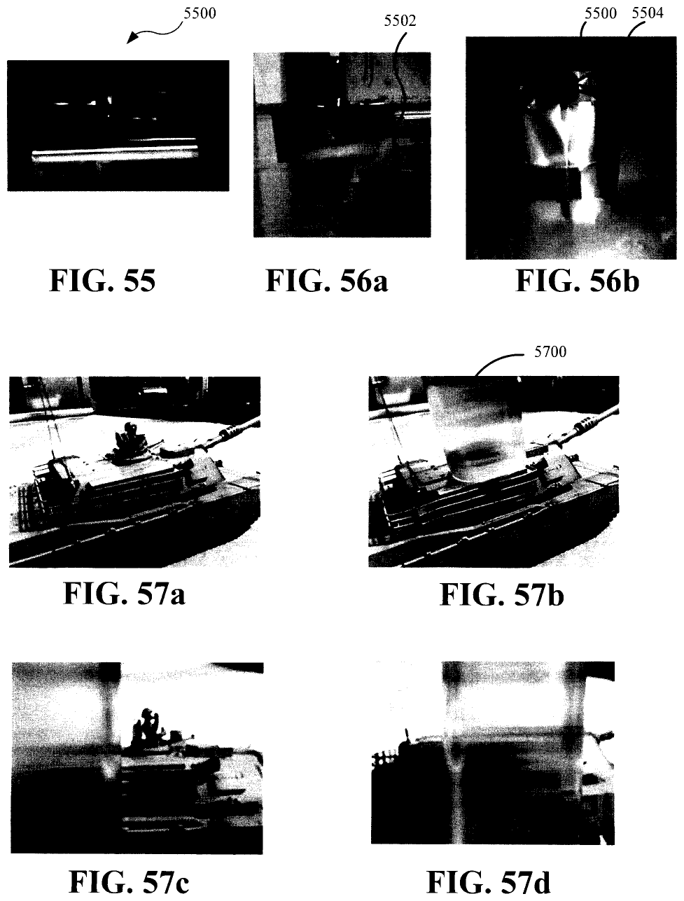

FIG. 55 depicts an object 5500 in the form of a quadcopter drone to which a lens sheet is to be applied before takeoff. The drone is then tested to see if the drone still functions and flies as expected.

In FIG. 56a, a lens sheet 5502 is applied to the front and back safety guards of the quadcopter drone object 5500. The sides are not covered see the difference in concealment resulting from the sheet 5502. Reflection can be mitigated with antireflective coatings or by using a wavy or semi-random set of waves within the mold for the lenses or a mesh cover over the lens.

FIG. 56b depicts the drone object 5500 with blade guards removed and lens sheet 5502 wrapped around the drone object 5500 in a cylinder shape. This embodiment removed the guard material that was visible against the lens and provided a much better concealment. As blades spin rapidly there is no highly visible part of the blade to hide. Most drones fly at altitude above an observer's head and thus there is little need to hide the top portion of the drone.

The embodiments depicted in FIGS. 55, 56a-56b may be used with helicopters, which use rotors to lift the craft and tilt them to adjust pitch of the blade to move it forward, backwards or side to side. Fixed wing aircraft or tiltrotor technology to combine the vertical performance of a helicopter with the speed and range of a fixed-wing aircraft, may make application much more difficult.

Again, reflection can be mitigated with antireflective coatings or by using a wavy or semi-random set of waves within the mold for the lenses, or with the use of with other embodiments of the lens sheet disclosed above that reduce lens flare. The embodiment of the lens sheet discussed above with reference to FIGS. 24a-24b (version 2) may work best as the mirror image effect against the sky as a background, may not be as noticeable as it may be on ground. Reducing reflection from lights leads to a visual signature that is drastically smaller and at typical observation distances, the drone object may not be visible to a viewer on the ground.

FIGS. 57a-57d are illustrations of an object in the form of a model tank utilizing a cylindrical lens sheet 5700 to avoid detection of at least a part of the object. One can hide the tank commander by placing him inside the cylindrical lens sheet 5700 as shown in FIG. 57b. When cylindrical lens sheet 5700 is placed on the ground beside the tank the commander is behind the cylindrical lens sheet 5700 as shown in FIG. 57d and would be able to look ahead without the material in his view but it would be difficult to detected him from the side.

### Cell Towers

With sufficiently large lens sheets, it is possible to hide almost any target object. However, in certain circumstances, safety considerations have to be taken into account such as when hiding cellular towers from ground view.

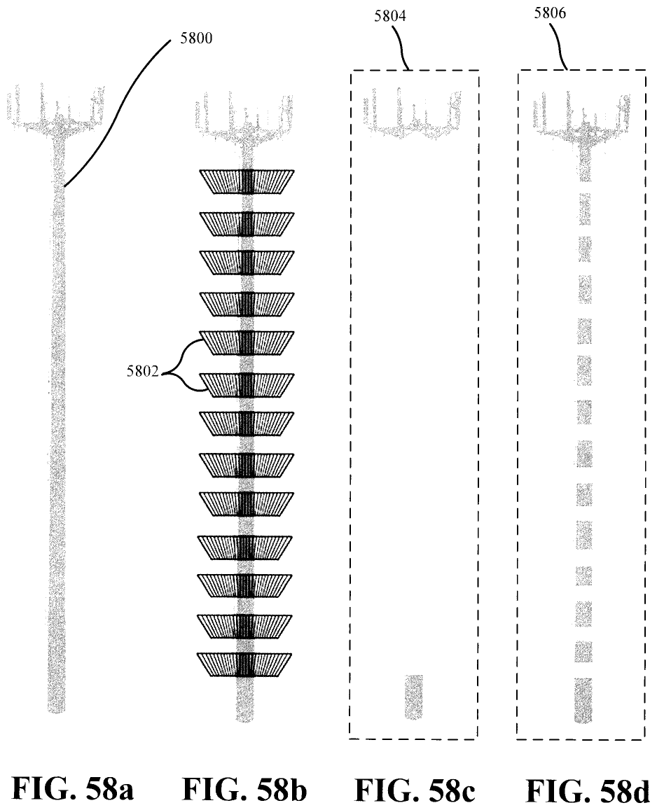

Wrapping a cylinder around a cell tower with an adequate standoff distance would also hide the tower from aircraft and in most cases that would be unacceptable. A proposed method, exemplary of an embodiment of the present invention, is to hide cellular towers or large antenna or any elongate member or structure from ground observation while still allowing overhead observation is demonstrated in FIG. 58a, FIG. 58b, FIG. 58c, and FIG. 58d.

A cell tower 5800 having a plurality of lens sheets 5802 disposed at an angle as shown in FIG. 58b will make the cell tower 5800 nearly invisible from view 5804 looking up from the ground as shown in FIG. 58c. However, the arrangement shown in FIG. 58b will allow an overhead view 5806 (e.g., from an aircraft or drone flying overhead) to include parts of tower 5800 as shown in FIG. 58d.

### Hunting Blinds and Privacy Inserts for Fences

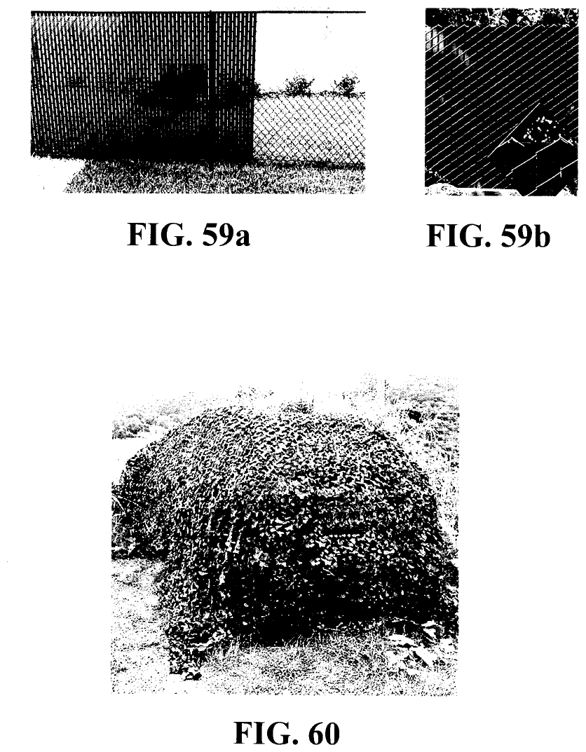

Hunting blinds can be made out of lens sheet material to allow a hunter to use one blind for several environments, seasons and times of day. Other exemplary uses in accordance with embodiments of the present invention include chain link fence privacy inserts made using lens sheets as shown in FIGS. 59a-59b.

Version 1 of the exemplary lens sheet, such as lens sheet 2300 of FIG. 23b, provides blurry color matching, good for homeowners. Versions 2-9 provide detailed images of the background but some objects can be hidden as described above.

Version 10 (depicted in FIGS. 35-36), Version 11 (depicted in FIGS. 37-38), and Version 12 (depicted in FIGS. 39-41) of the lens sheet arrangements may be used to provide color matching camouflage so that nothing could be identified through the lens sheet material.

Version 13 (depicted in FIGS. 42-45) may be utilized with either permanent double-sided lens sheet material manufactured with a set interference patterns or with two single-sided pieces having a clear lubricant or oil trapped in-between and a mechanism to allow the user to vary the interference pattern by adjusting the offset.

Soft pliable lens sheet material can be hung like a tent from poles or ropes or that can be supported by a rigid frame such as a pop out tent. Cutting holes in the material as is done with modern camouflage nets may be advantageous for camouflaging as shown in FIG. 60.

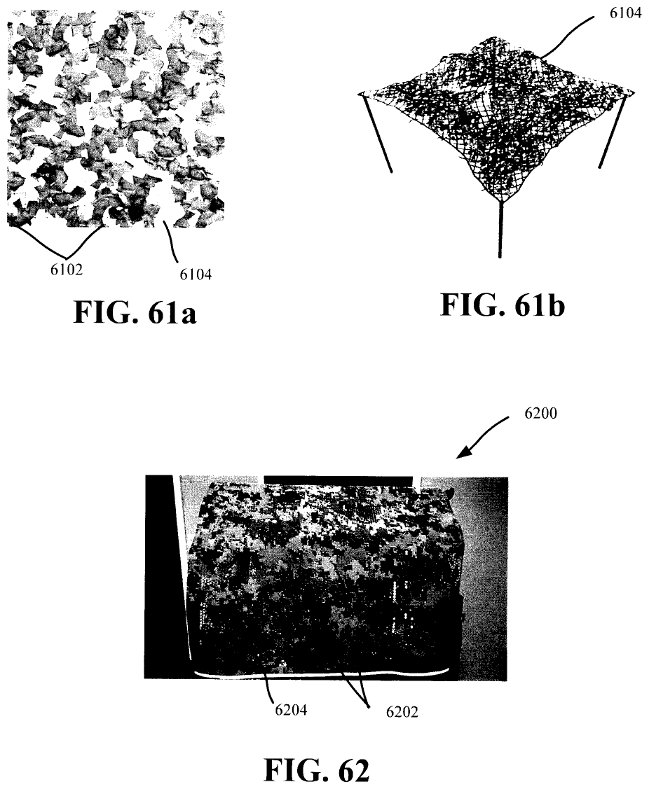

FIG. 61a and FIG. 61b depict laying strips 6102 of lens sheet material onto a net framework 6104.

FIG. 62 depicts an exemplary embodiment of providing a camouflage sheet 6200 with matrix of holes 6202 to retain the structural integrity of the sheet while providing holes for viewing out while retaining most of the camouflage concealment. This allowed for lighter weight of the sheet 6200 and air ventilation if the target object was completely enclosed on all sides. Any thermal signature through these holes was nearly unrecognizable, to a viewer as most of the target's thermal was blocked by the solid sections of sheet 6200. While the viewer may detect something was generating heat, the viewer would not be able to identify the object. In other embodiments, the camouflage sheet shown in the example may be replaced with numerous different types of lens configurations with similar holes.

### Lens Sheet with Variable Lens Elements

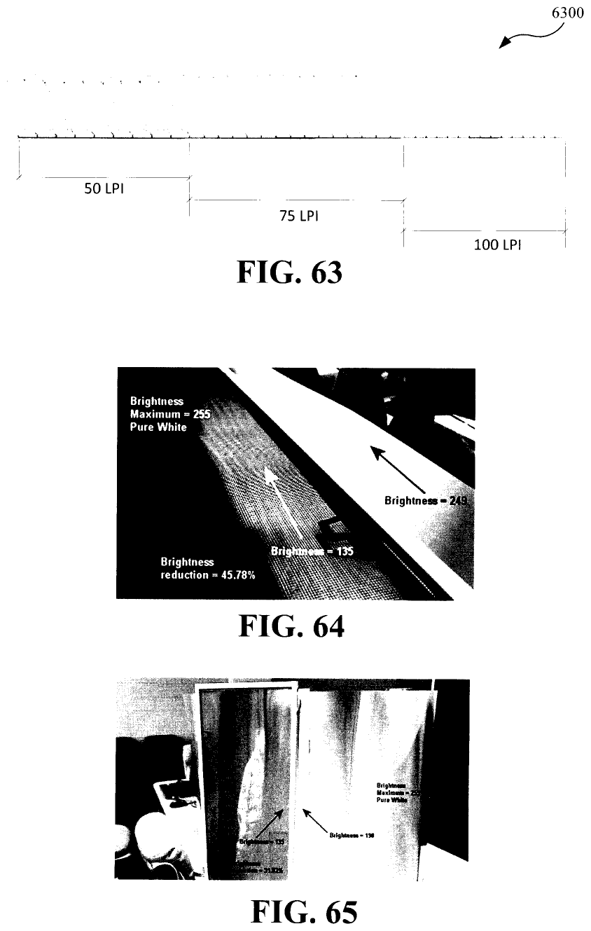

In some embodiments, a lens sheet with variable lens elements may be used to control whether and where the neutral zone shows up. As shown in FIG. 63, variable lenses where not all the lenses are exactly the same can be used to create a lens sheet 6300. For example the first set lenses (right to left) of lens sheet 6300 may be 100 LPI with a viewing angle of 42 degrees, then the next middle set of fifteen or so lenses are 75 LPI with a viewing angle of 49 degrees, then the next set of lenses are 50 LPI with a viewing angle of 54 degrees.

By placing another variable lens behind, lens sheet 6300 may be made double-sided, different configurations could be used to make the neutral zone larger or smaller or remove the neutral zones altogether.

In other embodiments, manufacture of the lens sheets depicted in FIGS. 35-45 not just, as a single-sided lens but potentially as a double-sided or two double-sided lens sheets with or without offset. The lenses on the second side are made to match the angle and lenses on the opposite side. In other embodiments, the lens sheets depicted in FIGS. 35-45 may be manufactured not just as single-sided lens sheets but also as lens sheet assemblies made up of one or more double-sided lens sheets, with or without an offset. The lenses on the second side do not have to match on some, all or any on the opposite side. Such configurations allow for the second side to be random or semi random in relation to the first side.

### Other Double-Sided Embodiments

The embodiments shown in FIGS. 10-11 having one angle prism lenses and embodiments of FIGS. 12, 13 having two angle prism lenses may be used in a double-sided lens assembly as shown in FIG. 3C, FIG. 15, and FIG. 2 double-sided lens sheet assembly such as FIGS. 16, 17a, 17b, 18-19, with variations of lens sizes as depicted in FIGS. 26b, 27b, 28b, 29b, 30b and 31b as well as configurations of FIGS. 35-45.

The dove prism lens sheet of FIG. 14 may also be split in the middle to allow for an offset assembly and allow for all configurations discussed in the above paragraph.

In other embodiments, a double-sided sheet may be same LPI with different angles. A lens sheet assembly having two double-sided sheets may be made up of a first double-sided lens sheet with identical LPI of a first density (e.g., 100 LPI) on both sides and a second double-sided sheet having different density (e.g., 75 LPI) but identical on both sides.

Adding blaze orange tint for hunting and other wildlife applications to part of the lens sheet or lens sheet assembly is advantageous as humans can see the sheet but animals with dichromatic vision cannot. Adding high visibility tints may also be used in commercial applications for safety.

In other embodiments with a double-sided lens the lenticular sides may face each other rather than away from each other. An antireflective layer, coating, mesh cover, textured surface or other overlay may be required for the smooth surface that faces away from the target and may further be required for the smooth surface that faces the target.

In other embodiments with a double sided lens the prism sides for prism lenses may face each other rather than away from each other. An antireflective layer, coating, mesh cover, textured surface or other may be required for the smooth surface that faces away from the target and may further be required for the smooth surface that faces the target.

### Anti-Reflective Coating

Addition of an antireflective coating over lenticular lenses improves the use of lens sheets exemplary of embodiments of the present invention. This is because reflections reduce the effectiveness of lens sheets and may hinder widespread use of methods exemplary of the present invention.

In some embodiments where the smooth surface of the single-sided version 1 embodiment depicted in FIGS. 23a-b, faces the observer, antireflective treatment such as coating, wavy lines or mesh may be required on the lenticule side. In other applications where a double-sided lens sheet has the lenticule side facing the observer, similar antireflective treatment may be required.

In addition to using antireflective coating or wavy lines to break up the lens flare effect, it is possible to add a mesh such as a bug screen to reduce the reflective glare that the sun or other light sources causes with lens sheets.

In the image depicted in FIG. 64 the lens sheet has the lenses facing up and reflecting the fluorescent lights from the ceiling. The uncovered portion has a brightness of 249 on the RGB scale of 255, which is the maximum pure white (on a 24-bit color encoding format having 8 bits per color). The covered portion has a brightness of 135, which represents a reduction of 45.78%.

The image depicted in FIG. 65, which is taken from experiments not aimed at attempting to use the lens sheet material in this configuration to mimic the background, the reduction is 31.82%.

The bug screen is made from black mesh so it is possible to use gray or a clear plastic mesh for a better overall effect of reducing the glare while still retaining the background colors. Many types of mesh materials can be used to reduce glare.

In some embodiments, a mesh piece, which may be black, white, colored or clear mesh, may be added directly on top of a lens sheet creating an antireflective coating.

In other embodiments, a mesh piece, which may be black, white, colored or clear mesh, may be added directly on top of the smooth side of a lens sheet creating antireflective coating. In some other embodiments, a textured surface can be added during manufacturing to the smooth side of a lens sheet creating antireflective surface. In yet other embodiments, a textured surface can be added during manufacturing to some or all of the lenticules of a lens sheet creating antireflective surface.

### Concealing Assets with Arch Covers, Structures and Buildings

The arch is a curved structure that is often used in residential, commercial and military infrastructures as it offers column-free, clear span interior, very long lengths and high ceilings. The strength of an arch also allows for added protection from falling debris, rain and snow. An added benefit of configuring the lens sheets in this fashion is that it is often column free and clear span, the arch can be small enough to be placed on top of headgear or mounted over the shoulders using shoulder harness or attached to a backpack to hide a person while allowing for full mobility.

Placed over a tank, boat, aircraft, building, an arch shaped lens sheet may be used to hide objects underneath and their shadows from visual, ultraviolet, infrared or thermal detection. The added benefit of the arch height is that any heat sources from objects underneath are often far enough from the lens sheet to avoid heating the lens sheet material and providing detectable thermal signature. The ends of the lens sheet arch can be open, or alternately fully or partially covered with the same lens sheet material. Partial coverage allows for airflow.

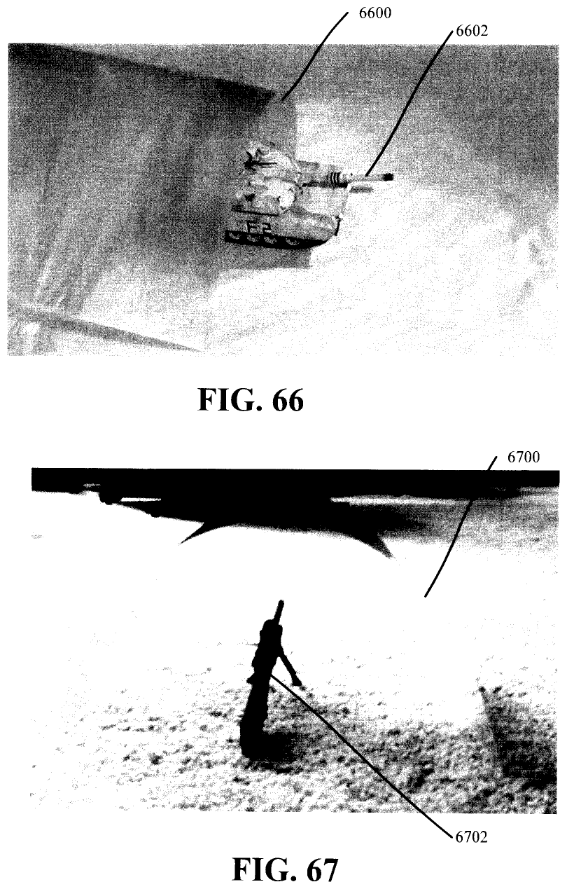

An exemplary arch shaped lens sheet 6600 is shown in FIG. 66. For illustration, in FIG. 66 a remote-controlled model tank 6202 is shown partially covered by lens sheet 6600.

As the lens sheet 6600 is scalable, making a large-scale structure to conceal a real tank may be as simple as scaling up the size of the lens and lenticules making up the lens sheet 6600. The depicted lens sheet 6600 shown similar to version 1 of the embodiments discussed earlier and illustrated in FIGS. 23a-b but with the lenses are disposed in the horizontal direction to hide the tank which is much longer in width than in height. Other exemplary versions of lens sheets discussed above may be used in this embodiment.

As version 1 of the exemplary lens sheet is prone to show the opposing polarization to the lens, the only detectable elements after close scrutiny are a few of the vertical lines of the tank 6202 and a few vertical gaps between the wheels are detectable but without any reference an observer may not be able to determine any threat.

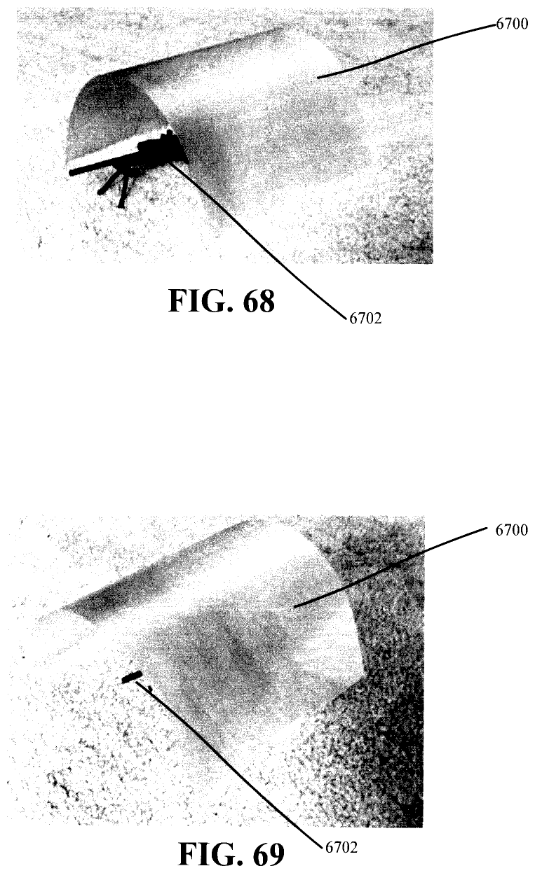

FIG. 67 depicts an exemplary arch shaped lens sheet 6700 used to hide an object in the form of rifle 6702. FIG. 68 and FIG. 69 depict the lens sheet 6700 covering progressively larger portions of the rifle 6702 thereby providing concealment from detection.

Snipers often get into position and hide for hours waiting for a target to come into their field of view. A sniper may not have time or the ability to move about freely to build a sniper cover, which is often made of items found in the same area to camouflage the snipers location. The exemplary arch shaped lens sheet 6700 shown in FIG. 67 may thus be used by a sniper to hide his body, and his rifle 6702.

Another added benefit to a sniper, intelligence, surveillance or reconnaissance person or group is that an open terrain with little cover would easily allow an adversary to detect them, is now a potential location to hide and observe.

To counter observation or encroachment by a sniper, the adversary will often choose a location, which is surrounded by open terrain devoid of cover such as trees, bushes, stumps, large rocks, hills. A sniper could utilize lens sheet 6700 as a front shield to quickly move into and open terrain position undetected, something that would take much longer without the concealing properties of lens sheet 6700 to avoid detection. An arch structure can conceal the sniper from observation atop, and can also be erected to hide from side observation. Currently, snipers would have to be as motionless as possible to go undetected but if their forward and rearward locations were concealed with lens sheet 6700, then movement detection would be reduced or eliminated allowing for extra freedom of movement.

Arches such as arch lens sheet 6700 may be self-supporting whereas other arches may be supported by a solid arch at each end which could be made from solid shaped arches or flexible rods that will take shape when unfolded, like a pop up tent. The support arches may also be required at predetermined lengths throughout the structure.

### Adding Strength to Larger Pieces

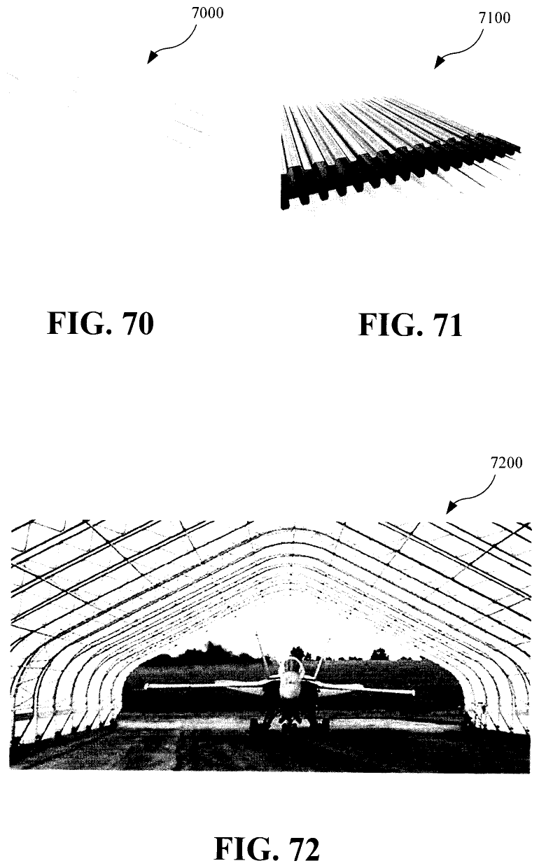

Large arch shaped lens sheets may require extra support. An exemplary support structure that may be utilized is a clear corrugated material such as corrugated material 7000 shown in FIG. 70. The lenticular lens may also be molded into this corrugated shape to combine the structural integrity of the corrugated shape and the concealing effects of the lens material.

Another exemplary structure that may be used is lenticular material 7100 having a corrugated shape including a piece that functions as a lens with a support structure as shown in FIG. 71. The nature of the shape of the corrugated material 7000 is somewhat similar in shape to a lenticular lens. The lenticular lens may also be molded into these corrugated shapes or others not shown.

A very large scale lens sheet may be manufactured similar to FIG. 2 where each lenticule width may be measured in inches, feet, yards or greater across, to allow scaling up for use an aircraft hangar 7200 as shown in FIG. 72 or in other larger structures.

### Hollow Lenticules and Temperature Regulation

As the weight of large-scale lenses may be cumbersome for transportation purposes, the lenses may be made hollow to be transported and assembled in place, then filled with a clear fluid such as water to allow for lenticular camouflaging functionality. Any version of the embodiments discussed above may be scaled up in this way, and other corrugated shapes may be manufactured.

The shapes of lens sheets structures are not limited to the arch embodiment but many variations may be used to create column free, clear span structures for better camouflaging than could be done in structures that required structural columns. The examples shown in FIGS. 70, 71 and 72 are only exemplary and in no way limiting.

Lenticular lenses for large-scale applications may later be filled with a fluid such as water or, if a more permanent structure is desired, a clear liquid that solidifies into a transparent medium. This allows the final lens sheet to function as expected. The lightweight hollow lenticular material may be removed like a mold once the clear liquid has solidified to take the lenticular shape.

Some or all of the liquid may be temperature regulated so that the liquid heating up does not create a temperature anomaly. Alternately, temperature regulation may be used to create a decoy thermal anomaly such as a farm animal, instead of a tank, or a thermal signature that simulates a car instead of a tank. Such thermal regulation may be critical in naval applications where water is typically colder than the surrounding air and this allows for easy thermal detection of ships, swimmers, and divers at the surface. Concealing objects in naval applications within this infrared and thermal spectrum may require the material to be cooled to match the water temperature to avoid detection.

Temperature regulation may also be used in the air with drones, or aircraft as the lens sheet made from hollow or flat lenticules typically takes on the surrounding air temperature, which near the ground is usually warmer than the sky, so a drone with the exemplary lens sheet at say 100 meters in altitude would be detectable against a cold sky background.

Temperature regulation may be accomplished by circulating fluid such as water through a hollow lens structure for naval or ground applications, but other systems could be employed for solid lenticular sheets such as blowing hot or cold air onto the material from the target object side or in some cases from the opposite side.

Regulating temperature of at least one of the plurality of elongate lenses may also be achieved by one or more of blowing warm air, blowing cold air, electrical heating or electrical cooling.

When using any of the above embodiments of lens sheets or lens sheet assemblies, it may be necessary to provide a viewing region to see through the lens sheet material. One way to do so is to utilize small cameras or pinhole cameras, which are mounted into the lens sheet material, affixed on to the surface of the material or provided on one or more edges of the lens sheet. A screen for use with the cameras can be hidden at a sufficient distance behind the lens sheet so that its viewable signature is reduced or eliminated. Glasses or goggles having a screen or a projected view onto the glasses or googles or a separate view screen may be used. With 360-degree cameras, a human target could utilize this technology for large situational awareness and remain hidden.

Surveillance operations may require these cameras to broadcast to other locations and/or to hide the presence of a surveillance system in any location. The target object to be concealed need not be a person but may be equipment, sensors, solar panels, cameras, technology or other installations or devices that potentially require external viewing and analysis.

A simple viewable solution is provided in FIG. 62 to create a matrix of holes to allow the hidden target behind to see through those sections while allowing the target to remain hidden. In applications where anti-thermal detection function is required, the matrix of holes may be clear sections of the same material as the lens to allow for outward vision while blocking thermal acquisition of any target behind.

A simple view port which is open or solid and clear or a movable viewing port flap may suffice for certain applications where the signature of the eyes or head are the only detectable part of the target may be acceptable in many applications.

Another solution for a viewable area is to perforate the lens sheet material with holes as is done in vinyl advertising for bus windows so that viewers close to the sheet can see out but a person at a father distance out attempting to acquire the target cannot see through the perforations. These perforations may be large or small and may be holes, which may be formed during, or after manufacture. Such holes may be filled with clear material at the manufacturing stage. Viewable perforations may take many different shapes including but not limited to: line, circle, ellipse, square, rectangle, triangle, hexagon, polygon and the like.

### Protective Sheet

In order to protect the lens surface from scratches, dirt, dust and the like, it may be necessary to manufacture a clear protective sheet or clear surface that can cover the elongate lenses or lenticules to make the lens sheet more durable and resistant to water buildup, dirt, scratches and other things which can reduce the overall effectiveness. A protective layer may be formed by coating or manufactured with protective elements to counter fog, water, fire, dirt, dust, scratches, heat, cold, ultraviolet rays and the like.

A protective sheet covering the elongate lenses may also utilize an antireflective layer, coating, mesh cover, textured surface or other overlay.

Having thus described, by way of example only, embodiments of the present invention, it is to be understood that the invention as defined by the appended claims is not to be limited by particular details set forth in the above description of exemplary embodiments as many variations and permutations are possible without departing from the scope of the claims.

What is claimed is:

1. A lens sheet comprising a first side and a second side opposite the first side, at least one of the first and second sides comprising:
a first plurality of elongate lenses disposed substantially in parallel, at a first density, in a first direction; and
a second plurality of elongate lenses disposed substantially in parallel, at a second density, in a second direction different from said first direction,
wherein the first and second plurality of elongate lenses are made of a substantially light transmissive material.

2. The lens sheet of claim 1, where each of the elongate lenses is a lenticule, a dove prism lens, a prism lens or a half dove prism lens.

3. The lens sheet of claim 1, further comprising a viewing region formed therein such that a target object behind one of the first and second side can see through the viewing region while hidden from an observer viewing the opposite side.

4. The lens sheet of claim 1, further comprising a protective layer formed by coating or manufactured with protective elements to protect said elongate lenses against one or more of fog, water, fire, dirt, dust, scratches, heat, cold, and ultraviolet rays.

5. The lens sheet of claim 1, wherein the viewing region is comprises one or more of holes, clear sections, perforations or a matrix of holes.

6. The lens sheet of claim 1, further comprising at least one camera mounted on the lens sheet and, and a screen onto images from the camera are transmitted.

7. The lens sheet of claim 1, wherein the first direction is different from the second direction.

8. The lens sheet of claim 1, wherein the first density is different from the second density.

9. The lens sheet of claim 1, wherein the second side comprises another plurality of elongate lenses to form a double-sided lens sheet.

10. The lens sheet of claim 8, further comprising a third plurality of elongate lenses disposed substantially in parallel at a third density, in a third direction, on said at least one side wherein the third density is different from the second density.

11. The lens sheet of claim 1, wherein one or more of an antireflective layer, antireflective coating, film, mesh cover, textured surface or overlay is disposed on at least one of the sides of the lens sheet to reduce reflection or improve shadow reduction.

12. The lens sheet of claim 1, wherein the lens sheet is cylindrical in shape.

13. The lens sheet of claim 1, wherein the lens sheet is arch shaped.

14. A double-sided lens sheet comprising:
a first side comprising a first plurality of elongate lenses; and
a second side opposite the first side, the second side comprising a second plurality of elongate lenses;
wherein the each of the first plurality of elongate lenses, and second plurality of elongate lenses are made of a substantially light transmissive material.

15. The double-sided lens sheet of claim 14, further comprising a viewing region formed therein such that a target object behind one of the first or second side can see through the viewing region while hidden from an observer viewing the opposite second or first side respectively.

16. The double-sided lens sheet of claim 14, where each of the elongate lenses is a lenticule, a dove prism lens, a prism lens or a half dove prism lens.

17. The double-sided lens sheet of claim 14, wherein corresponding ones of the first and second plurality of elongate lenses are in-line.

18. The double-sided lens sheet of claim 14, wherein corresponding ones of the first and second plurality of elongate lenses are offset.

19. The double-sided lens sheet of claim 14, further comprising a mesh disposed on at least one of the first and second sides.

20. The double-sided lens sheet of claim 19, wherein the mesh piece is one of: black, white, chromatic color or clear in color.

21. The double-sided lens sheet of claim 14, wherein the first plurality of elongate lenses comprises elongate lenses at a first density and a second density different from the first density.

22. The double-sided lens sheet of claim 21, wherein the second plurality of elongate lenses comprises elongate lenses at a third density and a fourth density different from the third density.

23. The double-sided lens sheet of claim 14, wherein the lens sheet is cylindrical in shape.

24. The double-sided lens sheet of claim 14, wherein the lens sheet is arch shaped.

25. The double-sided lens sheet of claim 24, further comprising support structures for the arch shaped lens sheet in the form of at least one of a solid shaped arch and a flexible rod.

26. The double-sided lens sheet of claim 14, wherein one or more of an antireflective layer, antireflective coating, film, mesh cover, textured surface or overlay is disposed on at least one of the sides of the lens sheet to reduce reflection or improve shadow reduction.

27. The double-sided lens sheet of claim 14, further comprising a protective layer formed by coating or manufactured with protective elements to protect said elongate lenses against one or more of fog, water, fire, dirt, dust, scratches, heat, cold, and ultraviolet rays.

28. A method of using of the double-sided lens sheet of claim 14, the method comprising:
placing the lens sheet between an object to be camouflaged and an observer, wherein light from the object undergoes, at least one of refraction and reflection such that the object is substantially invisible to the observer.

29. A cylindrical lens sheet comprising:
an outer side and an inner side, at least one of said outer and inner sides having a plurality of elongate lenses disposed thereon, each of the plurality of elongate lenses made up of a substantially light transmissive material;
wherein an object placed inside the cylindrical lens sheet is substantially invisible to an observer outside the cylindrical lens sheet, as light rays incident on the outer side are reflected and/or refracted by the at least one of said plurality of elongate lenses to exit the inside of the cylindrical lens sheet without being incident on the object.

30. The cylindrical lens sheet of claim 29, where each of the elongate lenses is a lenticule, a dove prism lens, a prism lens or a half dove prism lens.

31. The cylindrical lens sheet of claim 29, further comprising a viewing region formed therein such that the object inside the lens sheet can see through the viewing region while hidden from the observer.

32. The cylindrical lens sheet of claim 29, wherein said a plurality of elongate lenses are disposed on the inner side and said outer side is substantially flat.

33. The cylindrical lens sheet of claim 29, wherein said a plurality of elongate lenses are disposed on the outer side and said inner side is substantially flat.

34. The cylindrical lens sheet of claim 29, wherein said plurality of elongate lenses are disposed on both the outer side and the said inner side to form a first double-sided cylindrical lens sheet.

35. The cylindrical lens sheet of claim 34, further comprising a second double-sided cylindrical lens sheet concentric with the first double-sided cylindrical lens sheet.

36. The cylindrical lens sheet of claim 29 or claim 35, wherein one or more of an antireflective layer, antireflective coating, mesh cover, textured surface or overlay is disposed on at least one of the sides to reduce reflection or improve shadow reduction.

37. An arch shaped lens sheet comprising:
an outer side and an inner side, at least one of said outer and inner sides having a plurality of elongate lenses disposed thereon, each of the plurality of elongate lenses made up of a substantially light transmissive material;
wherein an object placed underneath the arch shaped lens sheet is substantially invisible to an observer outside the arch shaped lens sheet, as light rays incident on the outer side are reflected and/or refracted by the at least one of said plurality of elongate lenses to exit the inside of the arch shaped lens sheet without being incident on the object.

38. The arch shaped lens sheet of claim 37, further comprising a plurality of support columns to support said arch shaped lens sheet on a ground surface, wherein said object is on said ground surface.

39. A lens sheet comprising:
a first side comprising a first plurality of elongate lenses at a first density; and
a second side, opposite the first side, comprising a second plurality of elongate lenses at a second density;
each elongate lense made of a substantially light transmissive material, wherein the lens sheet is one of flat, curved, stiff or flexible and the lens sheet has a light ray convergence distance d.

40. The lens sheet of claim 39, where each of the elongate lenses is a lenticule, a dove prism lens, a prism lens or a half dove prism lens.

41. The lens sheet of claim 39, further comprising a viewing region formed therein such that a target object behind one of the first and second side can see through the viewing region while hidden from an observer viewing the opposite side.

42. The lens sheet of claim 39, wherein one or more of an antireflective layer, antireflective coating, mesh cover, textured surface or overlay is disposed on at least one of the sides to reduce reflection or improve shadow reduction.

43. The lens sheet of claim 39, wherein at least some of the elongate lenses have a wavy shape to reduce reflections.

44. The lens sheet of claim 39, wherein the first and second densities measured in lenses per inch (LPI) are the same.

45. The lens sheet of claim 39, wherein the first plurality of elongate lenses is offset from the second plurality of elongate lenses such that, upon placing the double-sided lens sheet between an object to be camouflaged and an observer, the observer views details of the background whereas the offset shifts the object and out of field of view of the observer.

46. The lens sheet of claim 39, wherein the first plurality of elongate lenses is offset from the second plurality of elongate lenses such that, upon placing the double-sided lens sheet between an object to be camouflaged against a background, and an observer, the offset shifts a neutral section to hide the object and surrounding background behind a neutral section thereby hiding the object from view.

47. The lens sheet of claim 46, wherein the lens sheet is manufactured as a single piece having one or more neutral sections at predefined areas of the lens sheet for hiding the object behind.

48. A lens sheet assembly comprising:
a first double-sided lens sheet comprising:
a first side comprising a first plurality of elongate lenses at a first density; and
a second opposite the first side, comprising a second plurality of elongate lenses at a second density;
a second double-sided lens sheet comprising:
a third side comprising a third plurality of elongate lenses at a third density; and
a fourth side opposite the third side, comprising a fourth plurality of elongate lenses at a fourth density,
wherein each elongate lens made of a substantially light transmissive material and wherein an object placed one side of the lens sheet assembly is substantially invisible to an observer on a second opposite side of the lens sheet assembly.

49. The lens sheet assembly of claim 48, where each of the elongate lenses is a lenticule, a dove prism lens, a prism lens or a half dove prism lens.

50. The lens sheet assembly of claim 48, further comprising a viewing region formed therein such that a target object behind one of the first and second side can see through the viewing region while hidden from an observer viewing the opposite side.

51. The lens sheet assembly of claim 48, wherein one or more of an antireflective layer, antireflective coating, film, mesh cover, textured surface or overlay is disposed on at least one of the sides to reduce reflection or improve shadow reduction.

52. The lens sheet assembly of claim 48, wherein the first, second, third and fourth densities measured in lenses per inch (LPI) are at the same LPI and the elongate lenses have the same lens angle, that allows for offsetting the elongate lenses on opposite sides of one or both of the double-sided lens sheets to shift an image of an object and surrounding background of the object.

53. The lens sheet assembly of claim 48 wherein said shift causes said image to be out of the field of view of the observer, replacing said background with that of one or both sides beside the object.

54. The lens sheet assembly of claim 48 wherein the elongate lenses are disposed vertically and the object is shifted left or right.

55. The lens sheet assembly of claim 48 wherein offsetting one or both of the double-sided lens sheets causes a shift in a view the object target behind a neutral section thereby hiding it from view.

56. The lens sheet assembly of claim 48, wherein each of the first and second double-sided sheets is manufactured as one piece having a neutral section in a predetermined location.

57. A lens sheet assembly comprising:
a first single-sided lens sheet comprising:
a first side comprising a first plurality of elongate lenses at a first density; and
a second substantially flat side opposite the first side,
a second single-sided lens sheet comprising:
a third side comprising a second plurality of elongate lenses at a second density; and
a fourth substantially flat side opposite the third side,
wherein each elongate lense is made of a substantially light transmissive material and wherein an object placed one side of the lens sheet assembly is substantially invisible to an observer on a second opposite side of the lens sheet assembly.

58. The lens sheet assembly of claim 57, where each of the elongate lenses is a lenticule, a dove prism lens, a prism lens or a half dove prism lens.

59. The lens sheet assembly of claim 57, further comprising a viewing region formed therein such that a target object behind one of the first and second side can see through the viewing region while hidden from an observer viewing the opposite side.

60. The lens sheet assembly of claim 57, wherein one or more of an antireflective layer, antireflective coating, film, mesh cover, textured surface or overlay is disposed on at least one of the sides to reduce reflection or improve shadow reduction.

61. The lens sheet assembly of claim 57, wherein the offset or angle between said two single-sided lens sheets produces a resonance wave pattern, which distorts the object.

62. The lens sheet assembly of claim 57, wherein the first density is different from the second density measured in lenses per inch (LPI).

63. A method of using the lens sheet of claim 39, comprising:
placing the double-sided lens sheet between an object to be camouflaged and an observer.

64. The method of claim 63, wherein the object is within said convergence distance of d from the sheet.

65. The method of claim 64, wherein the first and second densities measured in lenses per inch (LPI) are the same, and lens angle for said elongate lenses is the same, wherein said observer views details of a background of the object.

66. A method of using of a lens sheet comprising a plurality of elongate lenses, the method comprising:
placing the lens sheet between an object in to be camouflaged and an observer;
wherein the object is in front of a background, and a range of electromagnetic radiation from the object undergoes one or more of refraction and reflection such that the object is substantially concealed from the observer while at least a portion of the background is visible to the observer.

67. The method of claim 1 wherein the range of electromagnetic radiation is one of: ultraviolet (UV), visible (VIS), near infrared (NIR), short wave infrared (SWIR), mid-wave infrared (MWIR) and long-wave infrared (LWIR).

68. A method of shadow reduction comprising:
placing one or more lens sheets between a light source and the target, wherein the light passing through the sheet is refracted in numerous directions within the plane of the lenses thereby removing or reducing the visibility of shadow from the target.

69. A method of shadow reduction comprising:
placing one or more lens sheets behind a target with a light source in front of the target, each sheet having a plurality of lenses arranged in a plane, wherein light passing through said one or more lens sheets is refracted in numerous directions within said plane thereby reducing the visibility of a shadow from the target.

70. A method of shadow reduction of a target, comprising:
placing one or more lens sheets adjacent to the target, each sheet having a plurality of lenses arranged in a plane, wherein light from a light source and passing through the one or more lens sheets is refracted in numerous directions within the plane of the lenses thereby removing or reducing the visibility of shadow from the target.

71. The method of any one of claims 68 to 70, further comprising: providing at least some of the plurality of lenses with antireflective properties by way of one or more of antireflective layer, antireflective coating, film, mesh cover, textured surface and antireflective overlay to reduce reflections or improve shadow reduction.

72. A method of masking thermal signature from a target, from reaching a thermal detector, the method comprising:
placing the lenticular material between the viewer and the target, the lenticular material comprising at least one of: glass, plexiglass, plastic or acrylic, so that the thermal signature is prevented from being detected by the detector.

73. The method of claim 72 wherein said placing comprises enveloping the target with a blocking lenticular material.

74. The method of claim 72, wherein the thermal signature is an electromagnetic radiation in the infrared range.

75. The method of claim 72, further comprising regulating temperature of at least one of said plurality of elongate lenses by one or more of blowing warm air, blowing cold air, electrical heating or electrical cooling.

76. A method of manufacturing a lens sheet assembly comprising:
providing a first single-sided lens sheet comprising: a first side comprising a first plurality of elongate lenses at a first density; and a second substantially flat side opposite the first side,
providing a second single-sided lens sheet comprising: a third side comprising a first plurality of elongate lenses at a second density; and a fourth substantially flat side opposite the third side,
adjusting the offset angle between the first and second plurality of elongate lenses to produce a resonance wave pattern when viewing said lens sheet assembly.

77. The method of claim 76, further comprising providing at least some of the plurality of elongate lenses with antireflective properties by way of one or more of antireflective layer, antireflective coating, film, mesh cover, textured surface or overlay to reduce reflections or improve shadow reduction.

78. A method of manufacturing a lens sheet assembly comprising:
providing a plurality of hollow tubes adjacent one another, each of said tubes shaped like an elongate lens; and
filling said plurality of hollow tubes with fluid.

79. The method of claim 78, further comprising: removing said tubes to form said assembly.

80. The method of claim 78, further comprising: individually regulating the temperature of fluid in each of said tubes.

81. The method of claim 80, wherein said individually regulating said temperature of said fluid creates a decoy having a desired thermal signature to be observed by a thermal detector observing said lens sheet assembly.

82. The method of claim 78, wherein said fluid is water.
